(19) United States
(12) Patent Application Publication
(10) Pub. No.: US 2010/0068434 A1
(43) Pub. Date: Mar. 18, 2010

(54) Composite Material Compositions and Methods

(76) Inventors: Adam P. Steele, Urbana, IL (US); Ilker Bayer, Champaign, IL (US); Eric Loth, Champaign, IL (US)

Correspondence Address: WELLS ST. JOHN P.S., 601 W. FIRST AVENUE, SUITE 1300, SPOKANE, WA, 99201, US

(21) Appl. No.: 12/538,632

(22) Filed: Aug. 10, 2009

Related U.S. Application Data
(60) Provisional application No. 61/087,578, filed on Aug. 8, 2008.
(60) Provisional application No. 61/138,393, filed on Dec. 17, 2008.

(51) Int. Cl. C08K 3/22; C08L 27/12; B32B 15/08; B32B 27/04; B32B 1/08; C08K 3/34; C08L 93/04

(52) U.S. Cl. 428/36.9; 524/430; 524/432; 524/544; 428/421; 442/59; 524/445; 524/273; 524/413

(57) ABSTRACT

Compositions comprising a substrate having a layer thereover, the layer comprising a fluoropolymer and a nanofiller. Compositions comprising a substrate having a layer thereover, the layer comprising a fluoropolymer and a clay material. Methods for preparing a composite coating material solution, comprising: preparing a first solution comprising a fluoropolymer and an acetate; preparing a second solution comprising a clay material and a nanofiller suspension; and mixing the first and second solutions to form a composite coating material solution. Methods for applying a composite material layer to a substrate, comprising depositing a solution onto a substrate, wherein the solution comprises a clay material and fluoropolymer. Methods for applying a composite material layer to a substrate, comprising depositing a solution onto a substrate, wherein the solution comprises a fluoropolymer and a nanofiller.

### CROSS REFERENCE TO RELATED APPLICATION

This application claims priority under 35 U.S.C. §119 to U.S. Provisional Patent Application Ser. No. 61/087,578 entitled “Composite Material Compositions and Methods”, which was filed on filed Aug. 8, 2008, as well as U.S. Provisional Patent Application Ser. No. 61/138,393 entitled “Composite Material Compositions and Methods”, which was filed Dec. 17, 2008, the entirety of each of which is incorporated by reference herein

### GOVERNMENT RIGHTS STATEMENT

This invention was made with Government support under Grant Number 917-SBC.MINN T5306692501 awarded by the U.S. National Science Foundation Center for Compact and Efficient Fluid Power. The Government has certain rights in the invention.

### BACKGROUND

Numerous techniques of making water-repellent (superhydrophobic) surfaces, which mimic natural self cleaning surfaces such as the lotus leaf, have been demonstrated in literature. Water repellency has been accomplished by the generation of rough surfaces coated with low surface energy molecules, roughening the surface of hydrophobic materials, and creating well-ordered structures using micromachining and etching and laser ablation methods. Most of these techniques are based on physical and chemical surface modification of a single material system except for creating well-ordered structures such as aligned carbon nanotubes on various substrates. These techniques are generally limited by the amount of area that can be coated or treated at a time, and superhydrophobicity can be lost in time or as a result of mechanical rubbing of the surfaces. In addition to these techniques, nanocomposite film surfaces have been very recently considered to be an alternative platform for water-repellency. Nanocomposites are unique in the sense that otherwise incompatible material properties can be combined at the nano-scale effectively.

Although nanocomposites were initially developed for their superior mechanical, optical and transport bulk properties over conventional composites, it is now possible to fabricate superhydrophobic nanocomposite coatings as an additional benefit. The main challenge associated with superhydrophobic nanocomposite surfaces is the creation of hydrophobic surface roughness in which micro and nano-scale surface asperities are co-existent by using cost-effective single step processes. Recent studies have demonstrated that by attaching hydrophobic molecules such as fluorosilanes on the rough surface of a nanocomposite which is not water repellent, superhydrophobicity can be produced.

Superoleophobic surfaces have been achieved by only a handful of researchers to date, all of whom used either substrate limited or uneconomically scalable methods. However, superoleophobic coatings have many potential applications including fluid transfer, fluid power systems, stain resistant materials, and microfluidics. Thus, an economic superoleophobic coating with an easy application method could have a large impact in many industries. It is currently well known that the degree to which a solid surface repels a liquid mainly depends upon two factors: surface energy and surface morphology. The surface energy affects the liquid-solid surface interface by influencing the attractive forces between the liquid and solid at the molecular scale. Surface morphology alteration, on the other hand, at the micro- and/or nano-scale has been shown in numerous studies to allow for an air layer to be maintained in the space between the asperities, effectively reducing the solid-liquid surface contact area and increasing the apparent contact angle (i.e. the liquid repellency).

This distinction between surfaces that have a completely wetted contact area and surfaces that have an air layer with a fractional contact area are commonly explained by two independently developed models derived from the classical Young's equation (1): the Wenzel model given in equation (2) and the Cassie-Baxter model given in equation (3)

$$\begin{matrix}cos θ = \frac{{γ}_{sv} - {γ}_{ls}}{{γ}_{lv}} & ( 1 ) \\ cos {θ}^{*} = r cos θ & ( 2 ) \\ cos {θ}^{*} = - 1 + {φ}_{s} ( 1 + cos θ ) & ( 3 )\end{matrix}$$

Where γ is the surface tension; s, l, and v refer to the solid, liquid, and vapor phases, respectively; θ is the equilibrium contact angle; θ* is the apparent contact angle on the textured surface; r is the surface roughness; and φₛ is the fraction of solid-liquid contact. An oil droplet that is known to completely wet a surface is termed in the “Wenzel state” and tends to leave a stain as it slides and spreads. An oil droplet with a composite interface on a textured surface is termed in the “Cassie state” and may have substantially less surface adhesion.

Only a handful of synthetic superoleophobic surfaces have been created primarily due to the extreme difficulty in creating superoleophobic surfaces because oils and alkanes (such as decane and octane) have an equilibrium contact angle less than 90° on all currently known natural and artificial surfaces. The lowest surface energy end-groups in monolayer films that are currently known are —CH₂>—CH₃>—CF₂>—CF₂H>—CF₃ in decreasing order (—CF₃ has the lowest surface energy). The techniques that have been used to create superoleophobic surfaces to date include silicon etching with fluorosilane functionalization and anodically oxidized aluminum with fluorinated monoalkyl phosphate functionalization. A variety of other synthetic surfaces have been created that have shown high repellency to other liquids with mildly low surface tensions such as diiodomethane, but not for liquids with low surface tensions such as oils and alkanes. Fabrication methods for these surfaces include plasma modification of benzoxazine films, electrodeposition processes, silicone nanofilament growth and fluorosilane functionalization, and plasma polymer layers deposited on micro-rough PTFE substrates. Few polymer or nanocomposite coating methods have shown reasonable oleophobicity with no superoleophobicity reported to date.

Clay-based nanocomposites have had a wide impact on composite research due to vast applications of these nanocomposites ranging from mechanically tough products to barrier materials. Properties associated with clay-based nanocomposites originate from the high aspect ratio single clay platelets provided that the clay platelets are dispersed and exfoliated effectively in the polymer matrix. In its natural form, clay particles are vermicular stacks of several individual nano-platelets. Although many different nanocomposites with well exfoliated clay nano-platelets have been developed and commercialized, superhydrophobic clay-based nanocomposites are yet to appear. Polymer-based organic/inorganic nanocomposites in which the polymer matrix is a biopolymer (natural polymer) are generally known as bionanocomposites. Biocompatibility and biodegradability open new prospects for these hybrid materials with potential applications in regenerative medicine and in environmentally friendly materials (green nanocomposites). Biomedical applications such as wound dressing composites with tunable adhesion, self-cleaning properties as well as composite adhesives and coatings for bone surgery are particularly attractive applications. Cellulose nitrate has been used in making membranes for immunological and biochemical molecule analyses. In addition, when cellulose nitrate is dissolved in ether/alcohol solvent, the solution has been used as a surgical wound dressing.

Highly water repellent bionanocomposites were originally obtained from cellulose fibers by chemically attaching hydrophobic macromolecules on their surfaces using vapor/plasma or wet chemical deposition techniques. Surface topology of cellulosic micro-fiber networks decorated with such hydrophobic nanostructures satisfies the Cassie-Baxter wetting mode for durable superhydrophobicity and hence in all of these approaches an intrinsically rough cellulose based template was used as the substrate such as cotton fabric or paper. One of the major drawbacks in using bio-based polymers for conventional applications is their relatively poor mechanical stability and high temperature performance compared to conventional polymers. However, due to their biodegradability and biocompatibility as well as recent progress in designing biomaterial composites with properties comparable to conventional polymers, bio-based polymers have been finding increasing use in many applications such as food packaging, biomedical materials and coatings, surgical implants and even computer technologies. In addition to such conventional applications, design and fabrication of functional composite materials from bio-based polymers have also been explored. For instance, fabrication of highly water repellent composite coatings from hydrophilic biopolymers containing various antibacterial additives has been demonstrated recently.

A promising approach towards designing biopolymer composites with enhanced properties is to reinforce biopolymers with conventional polymers such as epoxy resins and natural and synthetic rubber as long as the polymer miscibility is thermodynamically feasible and a favorable polymer-polymer interfacial adhesion is maintained. For instance, polylactic acid (PLA) biopolymer samples toughened using rubber prepared from trimethyl carbonate showed 250% improvement in impact properties. Moreover, various techniques are available to tune surface and bulk morphology of biopolymers, for instance, solution inversion is used in polymer membrane fabrication to cast nano- and micro-porous hydrophilic (i.e., cellulose nitrate) and hydrophobic (i.e., polyvinylidine fluoride) polymer films. Introduction of a non-solvent into well dispersed polymer solutions can induce phase separation of the polymer. The phase inverted polymer morphology can be controlled by adjusting the type and the concentration of the non-solvent.

Here, simple and cost-effective solution-based techniques of fabricating robust nanocomposite and/or biocomposite coatings are disclosed.

### SUMMARY

Compositions are provided that can include a substrate having a layer thereover, with the layer including a fluoropolymer and a nanofiller. Compositions are also provided than can include a substrate having a layer thereover, with the layer including a fluoropolymer and a clay material.

Methods of preparing a composite coating material solution are provided with the methods including preparing a first solution comprising a fluoropolymer and an acetate; preparing a second solution comprising a clay material and a nanofiller suspension; and mixing the first and second solutions to form a composite coating material solution.

Methods can also provide for: preparing a first solution comprising a fluoropolymer, a silicone material, and a clay-based metalworking fluid; preparing a second solution comprising a rosin solution and a nanofiller suspension; and mixing the first and second solutions to form a composite coating material solution.

Methods of applying a composite material layer to a substrate are also provided that can include depositing a solution onto a substrate, wherein the solution comprises a clay material and fluoropolymer.

Other methods can provide for applying a composite material layer to a substrate, with the applying comprising depositing a solution onto a substrate, wherein the solution comprises a fluoropolymer and a nanofiller.

### DRAWINGS

Embodiments of the disclosure are described below with reference to the following accompanying drawings.

FIG. 1 depicts methods of preparing solutions according to an embodiment.

FIG. 2 depicts a method of preparing a solution according to an embodiment.

FIG. 3 depicts a method for applying solution and compositions according to an embodiment.

FIG. 4 depicts characteristics of compositions according to an embodiment.

FIG. 5 depicts characteristics of compositions according to an embodiment.

FIG. 6 depicts characteristics of compositions according to an embodiment.

FIG. 7 depicts characteristics of compositions according to an embodiment.

FIG. 8 depicts characteristics of compositions according to an embodiment.

FIG. 9 depicts characteristics of compositions according to an embodiment.

FIG. 10 depicts characteristics of compositions according to an embodiment.

FIG. 11 depicts characteristics of compositions according to an embodiment.

FIG. 12 depicts characteristics of compositions according to an embodiment.

FIG. 13 depicts characteristics of compositions according to an embodiment.

FIG. 14 depicts characteristics of compositions according to an embodiment.

FIG. 15 depicts characteristics of compositions according to an embodiment.

FIG. 16 depicts characteristics of compositions according to an embodiment.

FIG. 17 depicts characteristics of compositions according to an embodiment.

FIG. 18 depicts characteristics of compositions according to an embodiment.

FIG. 19 depicts characteristics of compositions according to an embodiment.

FIG. 20 depicts characteristics of compositions according to an embodiment.

FIG. 21 depicts characteristics of compositions according to an embodiment.

FIG. 22 depicts characteristics of compositions according to an embodiment.

FIG. 23 depicts characteristics of compositions according to an embodiment.

FIG. 24 depicts characteristics of compositions according to an embodiment.

FIG. 25 depicts characteristics of compositions according to an embodiment.

FIG. 26 depicts characteristics of compositions according to an embodiment.

FIG. 27 depicts characteristics of compositions according to an embodiment.

### DESCRIPTION

This disclosure is submitted in furtherance of the constitutional purposes of the U.S. Patent Laws “to promote the progress of science and useful arts” (Article 1, Section 8).

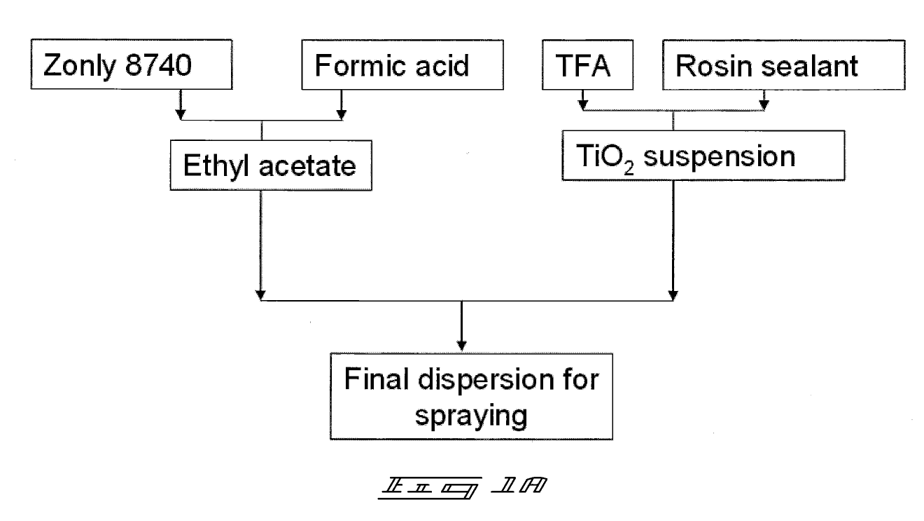

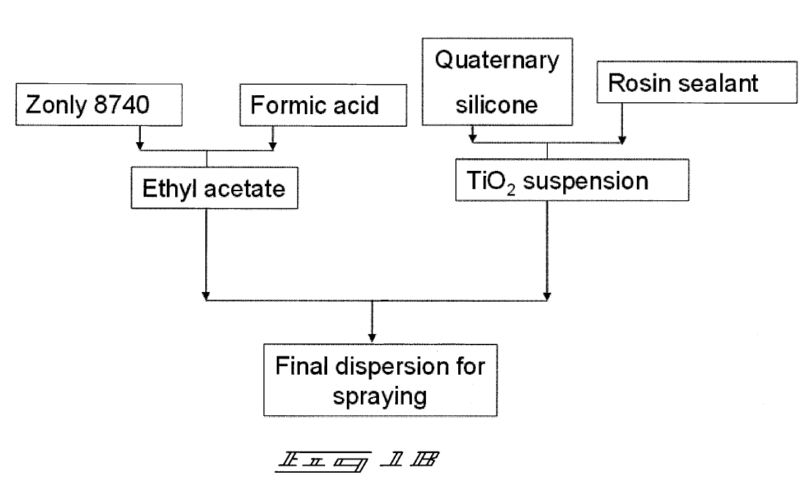

The coating materials and methods of the present disclosure are described with reference to FIGS. 1-27.

Referring first to FIG. 1, in accordance with an aspect of the disclosure, methods for preparing composite coating material solutions are provided that can include preparing a first solution and a second solution and mixing the first and second solutions.

According to an embodiment of this aspect, the first solution can include a fluoropolymer and an acetate. The first solution can further include a carboxylic acid. According to specific implementations, the first solution can include an acrylic fluoropolymer, ethyl acetate, and formic acid, for example. In accordance with FIG. 1A, about equal volumes of Zonyl 8740 (Du Pont, USA, the matrix can be a 30 wt % water dispersion of a perfluoro acrylic polymer) and ethyl acetate (Sigma-Aldrich, USA) can be mixed to form an emulsion. Formic acid can be slowly added until solution cleared.

In accordance with this embodiment of this aspect, the second solution can include a clay material and a nanofiller suspension. The second solution can also include a carboxylic acid. According to specific implementations, the second solution can include a clay-in-gum rosin, a metal oxide suspension, and trifluoroacetic acid (TFA, Sigma-Aldrich, USA). The clay material ((kaolinite) (1:1 type clay (Zeng Q H, Yu A B, Lu G Q, and Paul D R 2005, J. Nanosci. Nanotech. 5(10) 1574, hereby incorporated by reference)) filled gum rosin based thixotropic gasket sealant (clay-in-rosin composite) can be obtained from ITW Polymers, USA. Table 1 below lists the compositional details of the sealant. The sealant can be found to be dispersible in various solvents such as alcohols and ethyl acetate but not in water.

TABLE 1
Composition details of the clay-in-rosin based thixotropic
sealant based on manufacturer specifications.

| | % by | |
|---|---|---|
| Ingredient | weight | Class |
| Gum Rosin | 30 | Polymer matrix |
| Isopropyl alcohol | 10 | Solvent |
| Kaolinite-Al₂Si₂O₅(OH)₄ | 50 | Filler-clay mineral |
| Castor oil | 5 | Co-solvent |
| Lecithin | 5 | Surfactant |

With reference to FIG. 1A, for example, clay-in-rosin can be dispersed in ethyl acetate and the dispersion pretreated with TFA. About equal volumes of the TFA treated sealant dispersion and a nanofiller suspension such as the TiO₂ suspension (Table 2) can be mixed and the final mixture can be slowly added to the first solution to form a composite coating material solution. The nanofiller suspension can include a metal oxide and/or a carbon nanotube for example as well as one or more of a solvent, a plasticizer, and/or a surfactant. As an example, the nanofiller suspension can be prepared using a siloxane solvent/dispersant (Conley R F, Practical dispersion, Wiley-VCH, New York, p. 201, the entirety of which is incorporate by reference herein). The dispersion formulation can be adjusted such that forms conformal coatings with the help of surfactants and plasticizers (see Table 2). Table 2 below provides example compositional details of the solvent-based nanofiller suspension such as the TiO₂ suspension.

TABLE 2
Constituents of the solvent-based TiO₂ suspension.

| | % by | | |
|---|---|---|---|
| Ingredient | wt. | Class | Origin |
| Hexamethyl- | 32 | Solvent/dispersant | Sigma-Aldrich, USA |
| disiloxane | | | |
| Terpene | 16 | Solvent | (Cyclosolv ™, T2 |
| | | | Labs, USA) |
| Poly(isobutyl | 7 | Film forming agent | Sigma-Aldrich, USA |
| methacrylate) | | | |
| Dibutyl phthalate | 2 | Plasticizer | Sigma-Aldrich, USA |
| TiO₂ | 42 | Filler (~200 nm) | (Ti-Pure ®R-902+ |
| | | | rutile, DuPont, |
| | | | USA) |
| Sodium dioctyl | 1 | Surfactant | (Octowet 70 MS, |
| sulfosuccinate | | | Tiarco Chemical, |
| | | | USA) |

In accordance with another embodiment of this aspect, the second solution can further include a silicone material. According to specific implementations the second solution can include a clay-in-gum rosin; a metal oxide suspension, and a quaternary silicone such as silicone quaternary compounds. This embodiment is similar to the previous, except an about 15 wt % ethanol solution of the quaternary silicone liquid replaced TFA in FIG. 1A.

Embodiments of the deposition methods can provide for the removal of solvent from one or both of the mixture that can be deposited upon the substrate to form the composition. According to an implementation, the composition can be cured to remove solvents of the mixture. The curing can be performed at room temperature or at higher temperatures including the use of pressure differential chambers such as vacuum chambers, for example. According to other implementations, the solvent of the mixture may be substantially removed during deposition through the utilization of atomizing spray techniques. The deposited composite mixture can be substantially free of solvent upon providing curing. As an example, mixtures having an sufficient content of solvent may be substantially free of this content upon providing curing. Remaining in the composition, for example, can be the fluoropolymer and nanofiller according to example embodiments. As an example, each slurry solution can be spray coated on substrates such as glass slides and cured in an oven at 80° C. for three hours.

In accordance with yet another embodiment of this aspect of the disclosure, the second solution can include an anhydride such trifluoroacetic anhydride (TFAn, Sigma-Aldrich, USA). According to specific implementations, the second solution can include a tall oil fatty acid/montmorillonite and/or a nanofiller such as carbon nanotubes (nanotubes can have an average OD of 120 nm and length of 7μ and can be obtained from Sigma-Aldrich, USA). As an example of this embodiment, Zonyl 8740 can be blended with a water-based montmorillonite (2:1 type bentonite) filled tall oil fatty acid (TOFA) or reduced rosin dispersion. The bentonite filled thixotropic TOFA paste can be obtained from Sherwin-Williams Co., USA. Common solvents such as acetone, acetates and chlorohydrocarbons cannot be used to adjust viscosity without disturbing the stability of clay dispersion. Compatibilization of the paste with Zonyl 8740 fluoropolymer suspension can be achieved by mixing equal volumes of TFAn and the paste slowly while cooling to form a mixture. Upon the mixture cooling to room temperature, a stable suspension can be formed. Heat release can be observed and can be mainly due to reaction of TFAn with water to form TFA. After stabilization of the suspension, an equal volume of Zonyl 8740 can be added and diluted with ethanol to form a final slurry. The final slurry can be spray casted upon substrates surfaces to form layers which can be cured in an oven at 80° C. for three hours. To obtain coatings with carbon nanotubes, the carbon nanotubes can be mixed with the TFAn treated dispersion before blending with Zonyl 8740. A good degree of dispersion can be achieved.

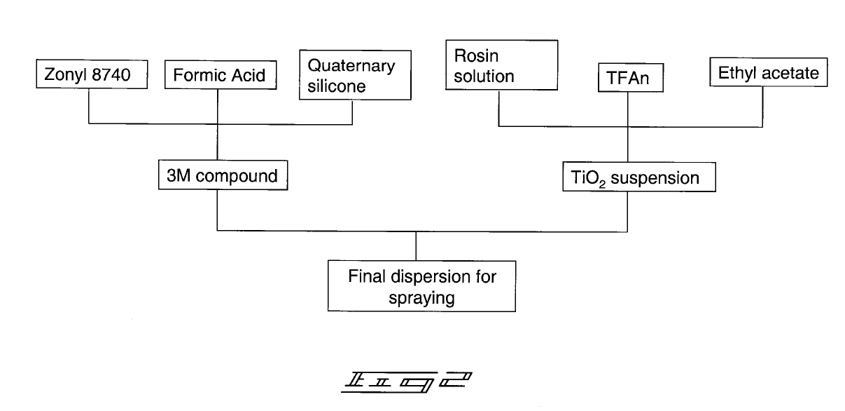

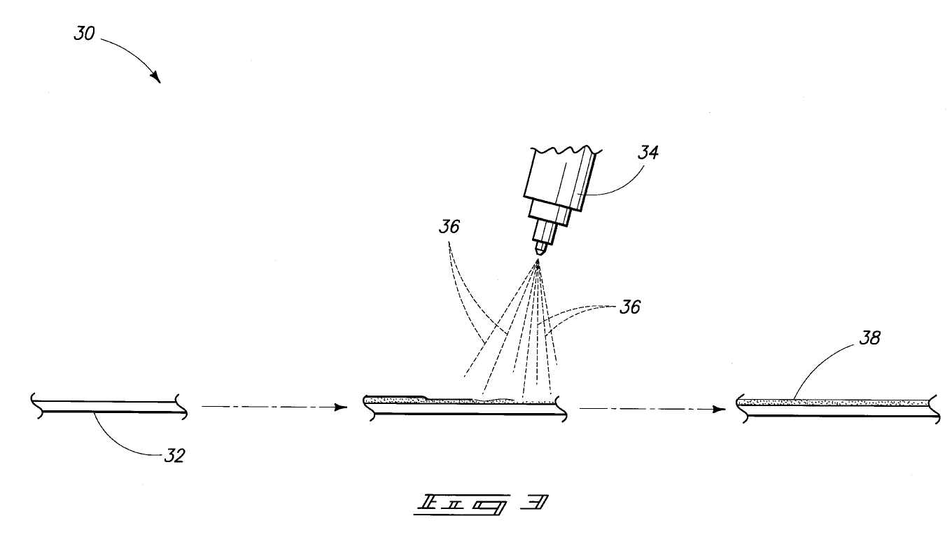

In accordance with another aspect of the disclosure and with reference to FIG. 2, a method of preparing a composite coating material solution can include preparing a first solution that includes the fluoropolymer, the silicone material, and a clay-based metal working fluid. According to example embodiments of this aspect of the disclosure, the first solution can include a compound having carbonyl functionality such as a carboxylic compound. In accordance with specific implementations of the embodiment, the first solution can include a fluoroacrylic polymer, a quarternary silicone compound, formic acid and a thixotropic clay-based metal working fluid.

The method can further provide for preparing a second solution that includes a rosin solution and a nanofiller suspension. According to an example aspect, the second solution can further include an anhydride and an ester. In accordance with specific implementations, the second solution can include a rosin gasket sealant, trifluoroacetic anhydride, ethyl acetate, and a metal oxide suspension.

As an example of this aspect and with reference to FIG. 2, a neat rosin gasket sealant (gasket shellac, 60 wt % rosin in isopropanol/castor oil solvent, ITW Polymers, USA), can be blended with the first solution. Clay (kaolinite) can be incorporated into the Zonyl solution from clay and quartz based thixotropic waterborne metalworking fluid obtained from 3M (see Table 3). The compound can have oleic acid and polyoxyethylene sorbitan monostearate (Tween 61) surfactants to provide for dispersion stability of kaolinite and quartz particles, for example.

TABLE 3
Composition details of quartz and silica based metalworking
fluid developed at 3M, USA for metal surface treatment.

| | % by | |
|---|---|---|
| Ingredient | wt. | Class |
| Water | 40 | Solvent |
| Quartz silica | 20 | Filler |
| Kaolinite-Al₂Si₂O₅(OH)₄ | 10 | Filler-clay mineral |
| Aliphatic petroleum | 20 | Co-solvent |
| distillates | | |
| Oleic Acid | 5 | Surfactant |
| Tween ® 61 | 5 | Surfactant |

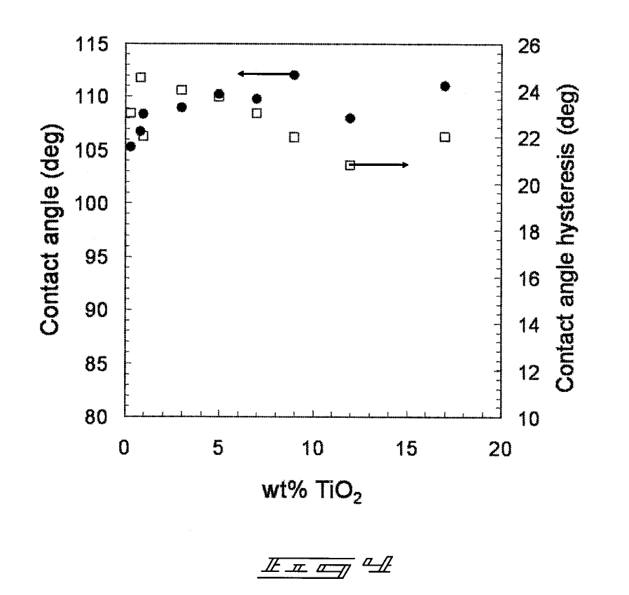

In accordance with another aspect of the present disclosure and with reference to FIG. 3, methods of applying these material solutions are provided that can include depositing a solution onto a substrate. With reference to FIG. 3, method 30 can include providing substrate 32. According to embodiments of the disclosure, substrate 32 can be one or more of a metal, ceramic, polymer, and/or biomass. Substrate 32 can be hydraulic equipment, marine vehicles, military vehicles, military arms, and/or construction materials. According to particular implementations, the substrate can be aluminum, rubber, textile materials, glass, concrete, and/or lexan. According to specific implementations, the substrate can be hydraulic equipment such as oil transfer tubes.

Referring again to FIG. 3, solution 36 exiting applicator 34 can include a clay material and a fluoropolymer. Applicator 34 is shown as a spray applicator such as an air-spray applicator. Solution 36 may also be provided to substrate 32 utilizing a brush applicator and/or via dipping substrate 32 to within solution 36 to provide composite material layer 38. In accordance with example implementations, solution 36 can include a solvent such as water, ethanol and/or an acetate.

In combination substrate 32 and composite material layer 38 can be considered a composition. This composition can include a fluoropolymer and a clay material. The clay material can be a clay-in-rosin material, a clay-in-gum rosin, a tall oil fatty acid, and/or thixotropic clay-based metal working fluid. The composition can further comprise a nanofiller such as one or both of a metal oxide and/or a nanotube with a specific example metal oxide being TiO₂ and the nanotubes being multiwall carbon nanotubes.

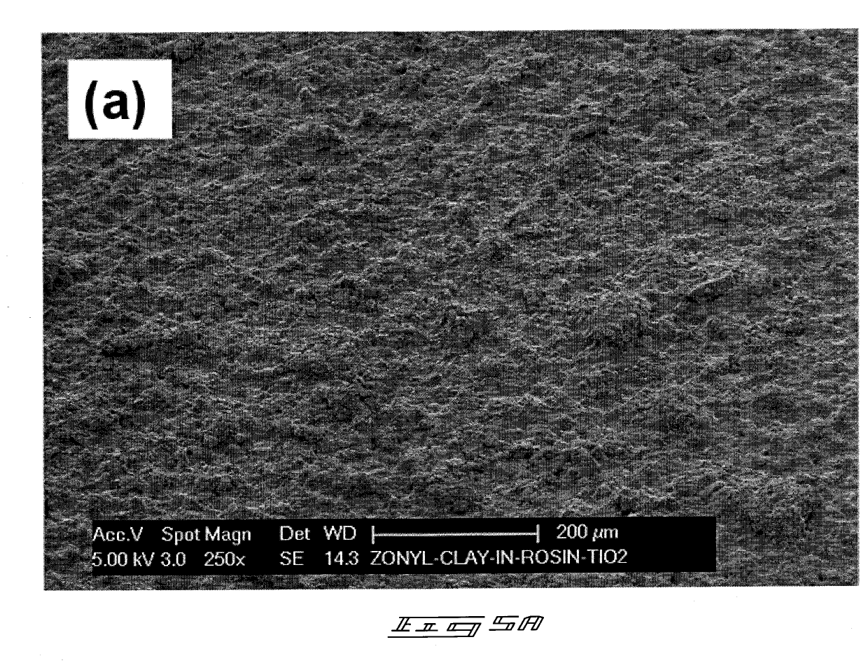

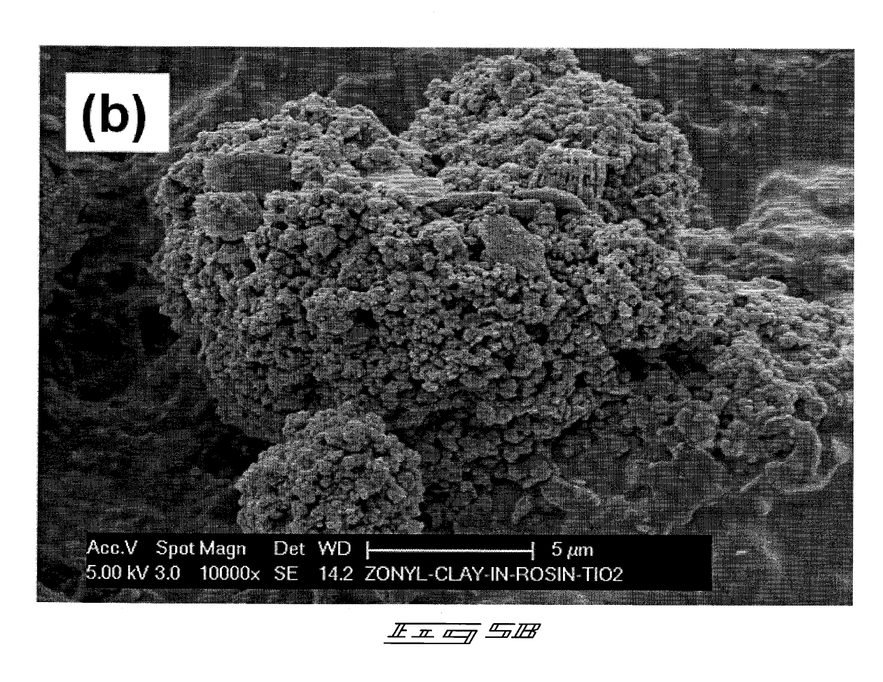

Surface wettability of individual blends of TiO₂ suspension and Zonyl 8740 can be studied. Blending of the two incompatible suspensions can be done by diluting the TiO₂ suspension with TFA and Zonyl 8740 with Acetone/Ethyl acetate co-solvent (˜20 wt %). TFA modified TiO₂ suspension can then be slowly added to the modified Zonyl 8740 solution to form a final slurry. FIG. 4 shows apparent contact angle (θ) and contact angle hysteresis (difference between advancing (θ_{A}) and receding (θ_{R}) contact angles) as a function of added TiO₂ weight fraction measured on spray cast perfluoro acrylic/TiO₂ composite coatings on glass slides. Coatings may now be superhydrophobic and wetting characteristics can be similar to neat Zonyl 8740. Similarly, contact angle hysteresis may not be affected as a function of TiO₂ weight fraction. These surfaces can be classified as conforming to Wenzel regime of wetting. The Zonyl polymer fraction in these coatings can be about 20 wt. %. The Zonyl content in the slurry can be reduced to below about 8 wt % whereupon a superhydrophobic (Cassie-Baxter type) surfaces can be obtained. However, substrate adhesion of the composite films can be observed to be highly deteriorated.

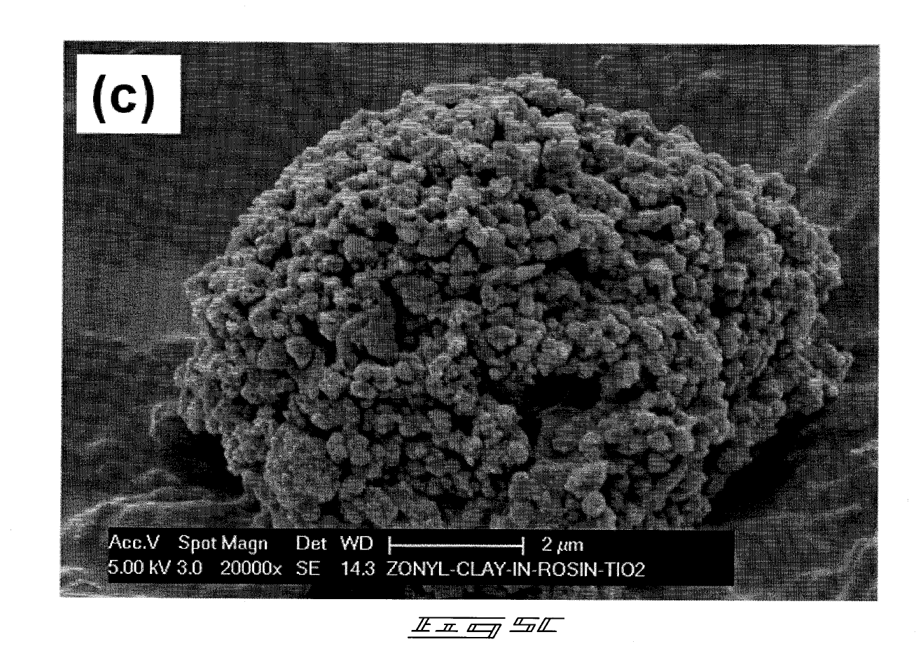

FIG. 5 (low magnification (a) and high magnification (b,c, and d) SEM images of perfluoroacrylic/clay-in-rosin composite surface prepared by FIG. 1A.) shows surface topography of TiO₂ filled perfluoro acrylic/clay-in-rosin composite surfaces prepared with the procedure of FIG. 1A. As can be seen in high magnification images, TiO₂ particles formed single and multiple spherullitic aggregates protruding away from the coating surface as shown in FIGS. 5B and 5C and most of the kaolinite particles can be in the form of layered clay (clay tactoids) with an average size of 4 microns (FIG. 5D). Arrows in FIG. 5D indicate a polymer coated clay tactoid. Although a polymer coating layer is apparent on the exposed side of the tactoid, intercalation may not be clearly visible. Based on detailed scanning electron microscopy (SEM) analysis of the surfaces, clay tactoids can be mostly found to be embedded in the TiO₂ aggregates (FIG. 5C). This unique surface morphology displays a good combination of micro and nano scale self-similar surface roughness as well as inherent hydrophobicity which are required to maintain surface water-repellency.

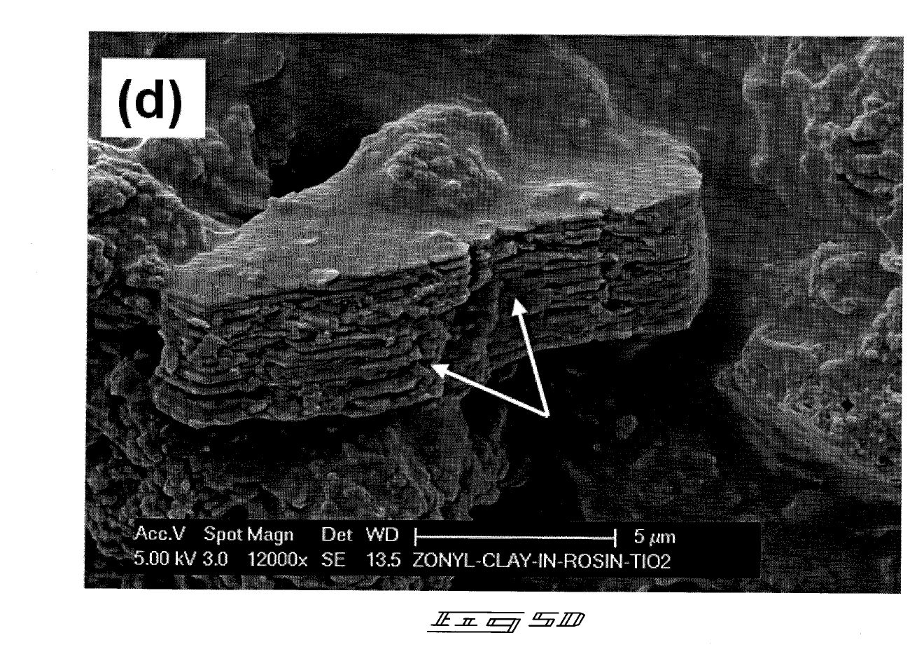

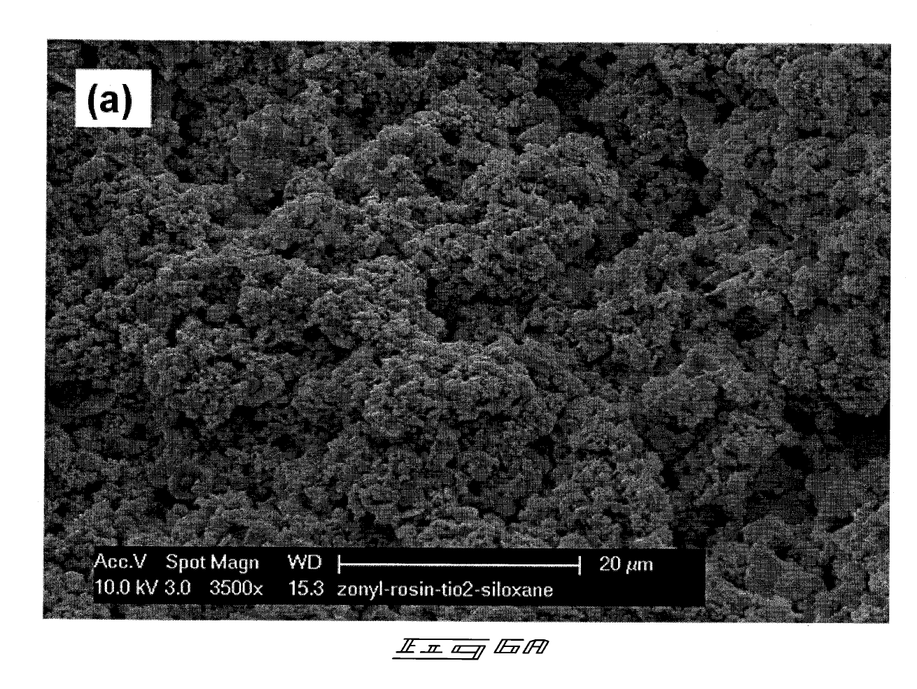

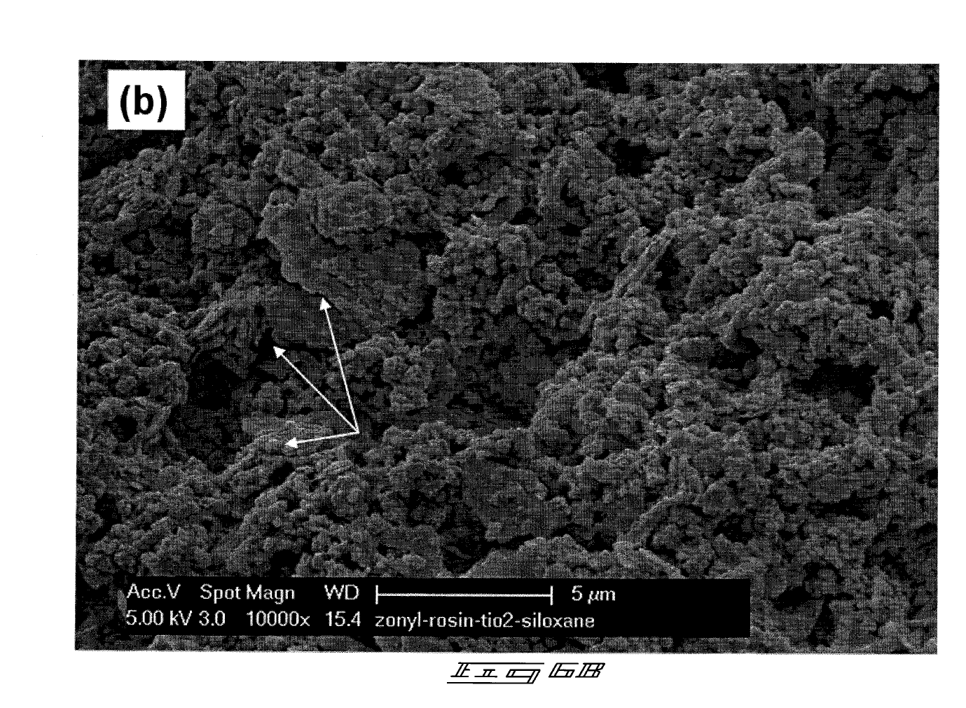

When the clay-in-rosin sealant is modified with a silicone quaternary compound instead of TFA (according to the method of FIG. 1B), final coating surface morphology can be affected as shown in FIG. 6 although self-similar surface roughness features can be preserved. Detailed SEM analysis of these surfaces showed that most of the kaolinite nano-platelets can be exfoliated and dispersed in the polymer matrix. This observation appears to be in agreement with the general practice of exfoliating clay nano-platelets in polymer matrices by functionalizing their surfaces with organo-silicones prior to inclusion. Such enhanced dispersion of individual nano-platelets brings in superior mechanical and transport properties to polymer/clay nanocomposites [12]. Qualitative observations can indicate the rosin based superhydrophobic surfaces can have good substrate adhesion as well. In FIG. 7(Low (a) and high (b) magnification self-similar surface morphology of TiO₂ filled perfluoroacrylic polymer/clay-in-rosin composite surface prepared by GRS 1b (FIG. 1B), effect of perfluoroacrylic polymer concentration on the degree of water-repellency of the composite surfaces prepared by procedure of FIG. 1 is shown. Coatings obtained from quaternary silicone treated clay-in-rosin systems (FIG. 1B) can display slightly better water-repellency compared to TFA treated system (FIG. 1A). It can be found that the critical perfluoro acrylic polymer concentration, which rendered the composites hydrophobic, is approximately 6 wt %.

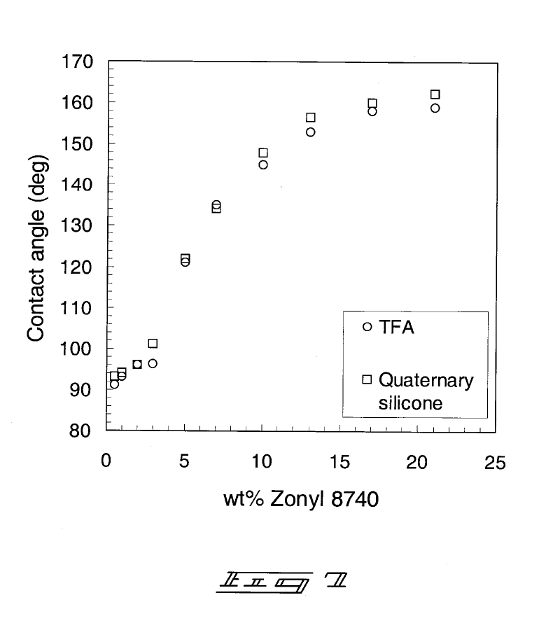

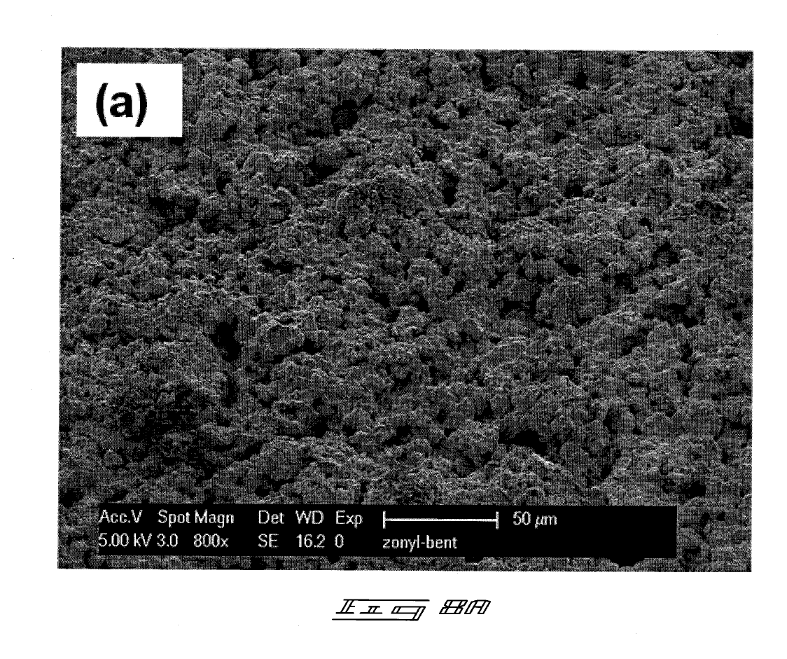

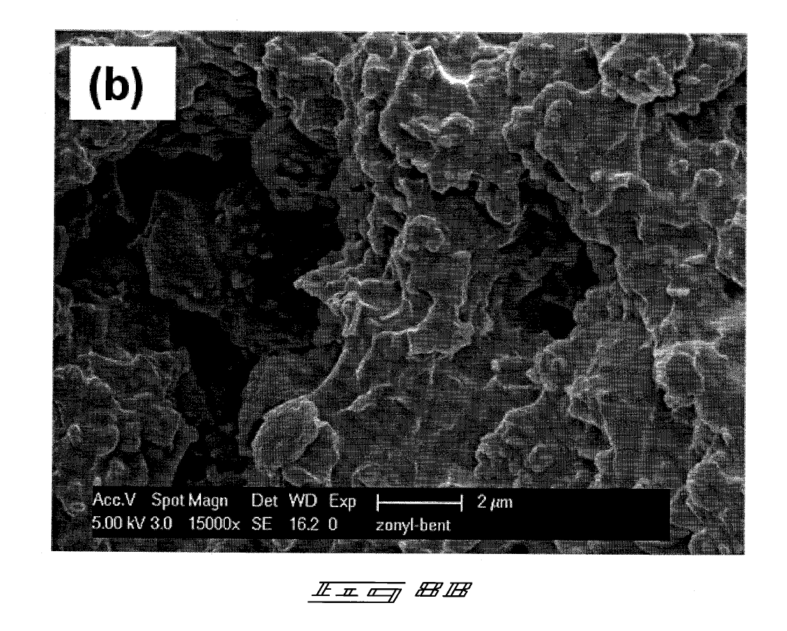

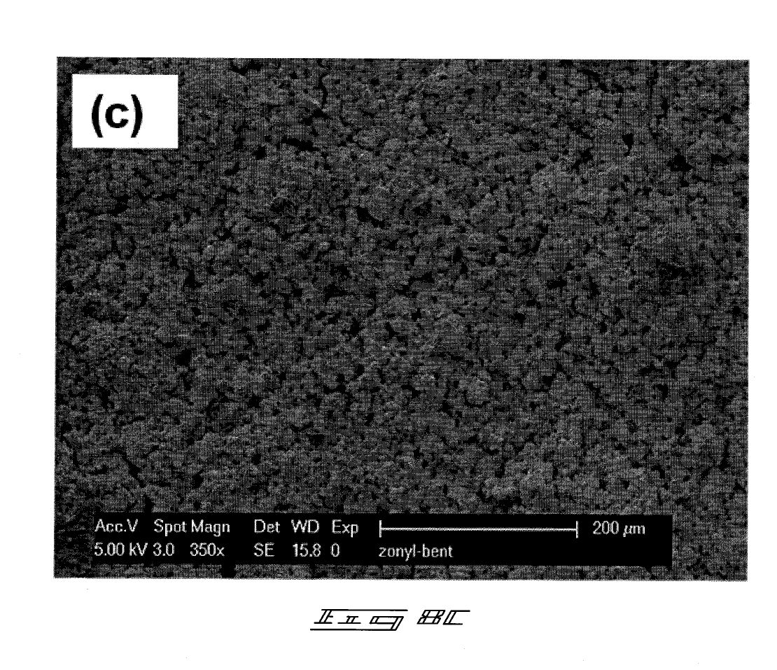

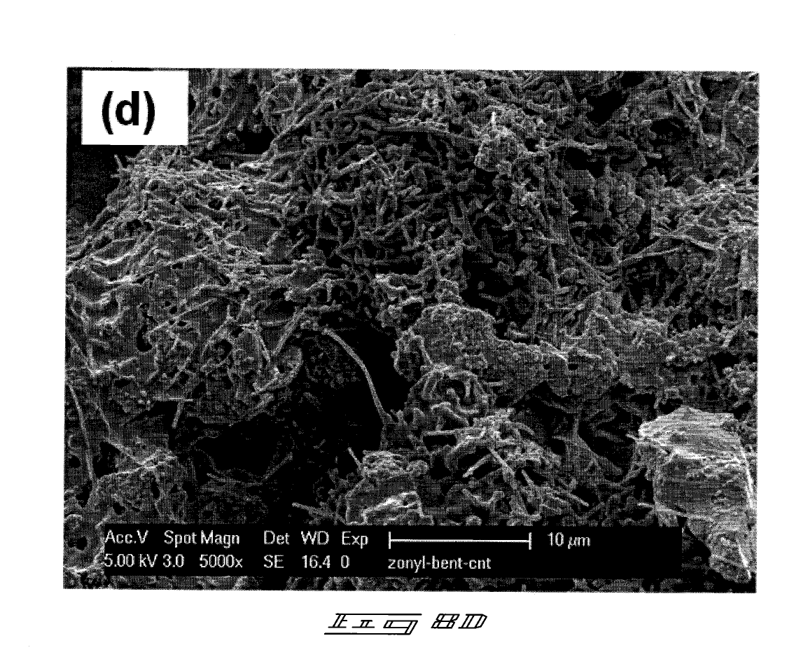

Coatings fabricated by utilizing an industrial cutting fluid which is a waterborne reduced rosin dispersion filled with quartz silica and bentonite clay were studied, and it can be found that TFAn shows effective viscosity reduction while maintaining dispersion stability of the fillers, clay and quartz. Part of TFAn was converted to TFA with moderate heat release due to presence of water as the main solvent in the metalworking fluid. It can also be found that due to the formation of TFA, proper dispersion of nanotubes in the suspension upon mixing was also possible. Surface morphology of the superhydrophobic surfaces obtained from procedure this formulation is presented in FIG. 8. Formation of self-similar hierarchical surface roughness is evident from FIG. 8A. In FIG. 8B, a good dispersion of quartz and TiO₂ particles over the bentonite surfaces coated with a thin polymer blanket is visible. Based on detailed SEM analysis of the surface, interspacing between most of the bentonite platelets can be higher than the kaolinite platelets shown in FIG. 5 which indicates a substantial clay intercalation. In FIG. 8C, nanotubes filled superhydrophobic surface morphology is shown. The added nanotubes appear to have been distributed in an anisotropic fashion (see FIG. 9) but well separated from each other. The apparent fishbone like surface architecture as a result of nanotube inclusion (between 5-10 weight percent) can render the hydrophobic composite surface superhydrophobic (see FIG. 10B). Due to the existence of nanotube networks on the surface, which results in a high aspect ratio nanostructured surface decoration, considerable improvement in water-repellency can be observed. In a typical coating, the surface density of nanotubes can be estimated to be roughly 50 million/cm² (at 8 wt % nanotube filling).

Referring to FIG. 10A, effect of the relative concentration of TFAn modified clay-in-reduced rosin on the water-repellency of composite coatings is shown. The apparent contact angle increases as a function of added TFAn modified clay-in-reduced rosin. Superhydrophobic wetting regime can be maintained at concentrations of 16 wt % and above with embodiments having optimum modified clay-in-reduced rosin concentration can be 30 wt %. Concentrations exceeding 40 wt % can demonstrate a reduced apparent contact angle and superhydrophobicity can be diminished to zero. At 16 wt % clay-in-reduced rosin concentration in the composite, addition of nanotubes can result in an increase in hydrophobicity (FIG. 10B). However, at nanotube loadings exceeding 12 wt %, superhydrophobicity can be diminished to zero and the surface wetting can be similar to a hydrophobic graphite surface wetting and hence by adjusting relative concentrations of clay-in-reduced rosin and nanotubes depending on the application surface wettability of the composite coatings may be manipulated.

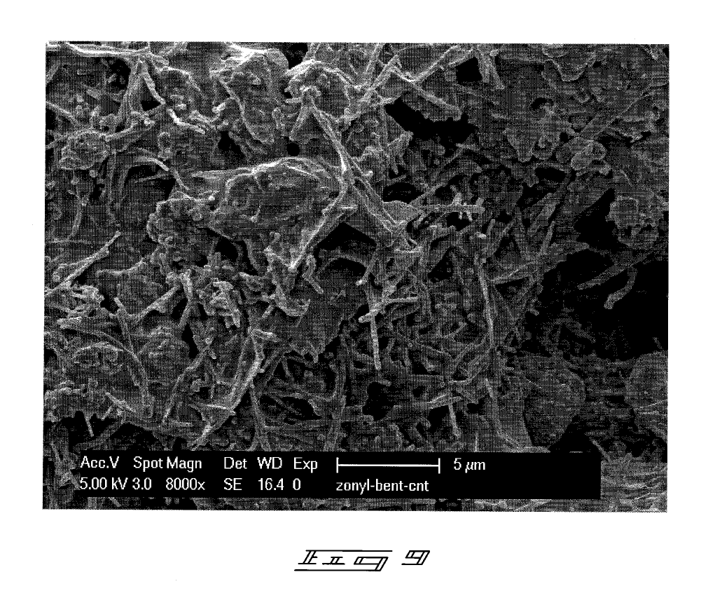

Referring to FIG. 11, low (a) and high (b) magnification scanning electron micrographs of clay and quartz filled perfluoro acrylic polymer/neat rosin composite surface prepared by in accordance with FIG. 2 are shown. The surface morphology is very similar to the superhydrophobic composite surfaces containing reduced rosin (TOFA) prepared by procedure TOFARS (FIG. 2).

Surface morphology of coatings fabricated by the procedure of FIG. 2 can be similar to surface morphology of the composites fabricated by TOFARS (see FIGS. 8A and 11A). Kaolinite within the composite polymer matrix can be observed to be intercalated by and large and some exfoliated (indicated by arrows in FIG. 11B). Intercalation of clay in the composites may be related to the use of oleic acid as surfactant in the original formulation (Table 3). According to example implementations, in order to obtain superhydrophobicity by GRS a maximum of 8 wt % Zonyl inclusion was adequate contrary to the higher concentrations (˜15-20 wt %) required for the surfaces prepared in accordance with FIG. 1 and the TOFAR formulations described herein.

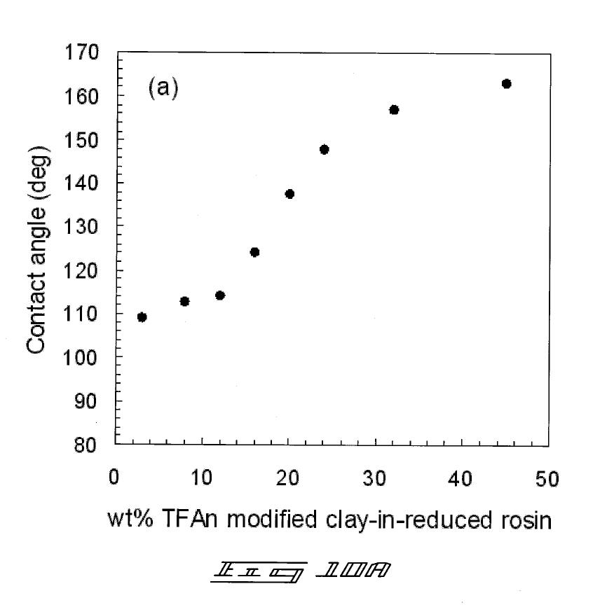

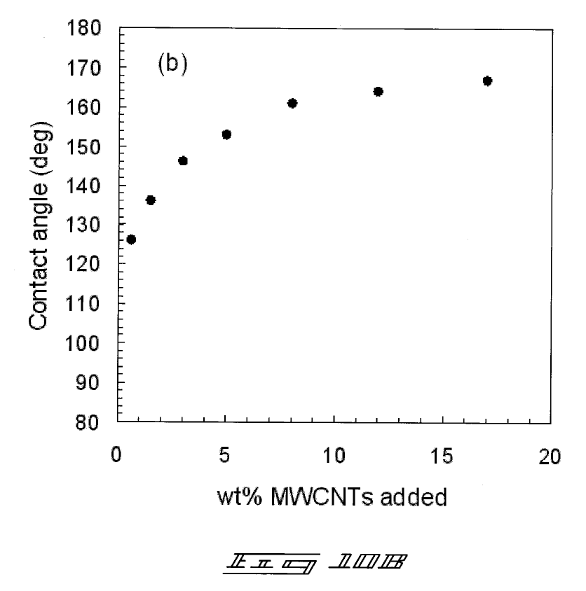

Referring to FIG. 12, apparent contact angle (a) and contact angle hysteresis (b) as a function of Zonyl 8740 weight fraction is shown using 8 wt % TiO₂ enhanced water repellency of the coatings. No substantial change in contact angle hysteresis was observed as a function of TiO₂ loading.

In FIG. 12A, effect of Zonyl weight fraction on the composite surface water repellency is shown with and without TiO₂ inclusion. As seen, at 6 wt % (critical concentration) and above Zonyl concentrations highly water repellent surfaces can be obtained when TiO₂ was present. Contact angle hysteresis can also be measured as a function of Zonyl weight fraction (FIG. 12B) and considerable reduction in contact angle hysteresis can be apparent at the critical Zonyl concentration. Surface wettability of the composites conformed to Cassie-Baxter wetting regime with minimal contact angle hysteresis.

In accordance with example implementations, a simple and one step deposition technique to fabricate superhydrophobic clay-based nanocomposite coatings filled with TiO₂ and nanotubes from stable suspensions is provided. The use of hydrophobic molecules may not be necessary to treat the fabricated nanocomposite surfaces and render them superhydrophobic. The fabrication technique can be presented as three separate procedures which may differ due to the source of rosin-in-clay component used. The nanocomposites can be prepared from a blend of a waterborne perfluoro acrylic polymer emulsion (Zonyl 8740) and the aforementioned clay-in-rosin compounds. Coatings can be obtained by spray casting from multi-component solution-based slurries on glass slide substrates; however, additional substrates may be utilized. It can be found that trifluoroacetic acid (TFA), trifluoroacetic anhydride (TFAn) and silicone quaternary compounds can be effective co-solvents providing compatibilization of the water insoluble clay-in-rosin and the waterborne perfluoroacrylic polymer. Typically, clay may be in the form of layered clay (conventional form) in the nanocomposites fabricated by FIG. 1A, exfoliated in the nanocomposites fabricated by FIG. 1B and intercalated in the nanocomposites fabricated by procedures TOFARS and in accordance with FIG. 2. Exfoliation of clay platelets can be achieved by the use of a silicone quaternary compound/co-solvent. In TOFARS, a good degree of nanotube dispersion may also be observed due to the presence of TFAn co-solvent which also functionalized the nanotubes in solution.

Regardless of the form of clay in the nanocomposites, superhydrophobicity can be observed in all coatings. This may be attributed to the formation of hydrophobic micro- and nano-structured self-similar surface roughness which is required for superhydrophobicity. Nanocomposite coatings fabricated from in accordance with FIG. 2 may require minimal use of the perfluoro acrylic polymer (˜8 wt %) compared to the other formulations with good degree of substrate adhesion (˜15-20 wt %)

In accordance with yet another aspect of the present disclosure, methods for applying a composite material layer to substrate are provided that includes depositing a solution onto a substrate with the solution including a fluoropolymer and a nanofiller. The solution can include a solvent and this solvent may be polar for example. The solvent can be one or more of an alcohol, ketone, and/or water. In accordance with example implementations and with reference to FIG. 3, the depositing can include atomizing the solution. Upon depositing, the method can further provide for curing the deposited composite materials with the curing including providing energy in the form of heat and/or pressure differential.

The deposited composite materials and substrate can represent a composition that includes the substrate having a layer thereover, with the layer comprising a fluoropolymer and a nanofiller. The nanofiller can be a nanoscale particle configured to disperse within the layer. Example nanofillers include metal oxides such as ZnO. The nanofiller can include a metal from Groups III through VIII and IB and IIB of the periodic table of elements as well as transition metals and alkaline earth metals such as those in groups IA and IIA. The fluoropolymer can be a copolymer, it can be water-based, and/or a fluoroacrylic polymer such as perfluoroalkyl methacrylic copolymer.

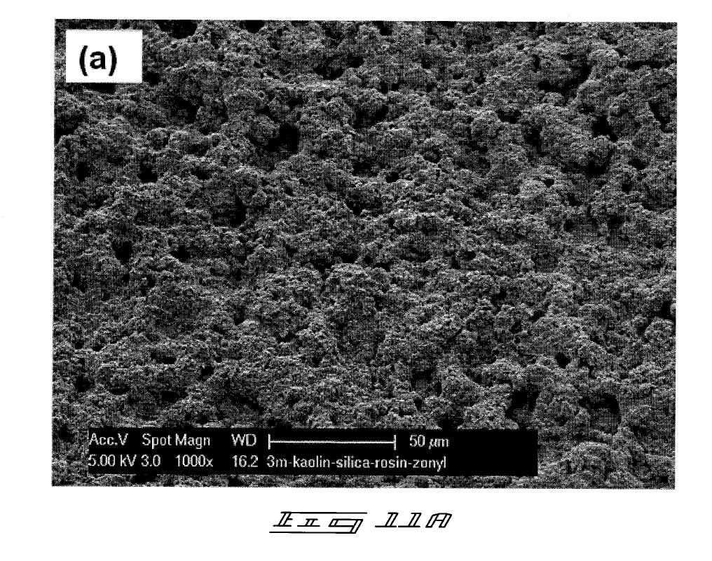

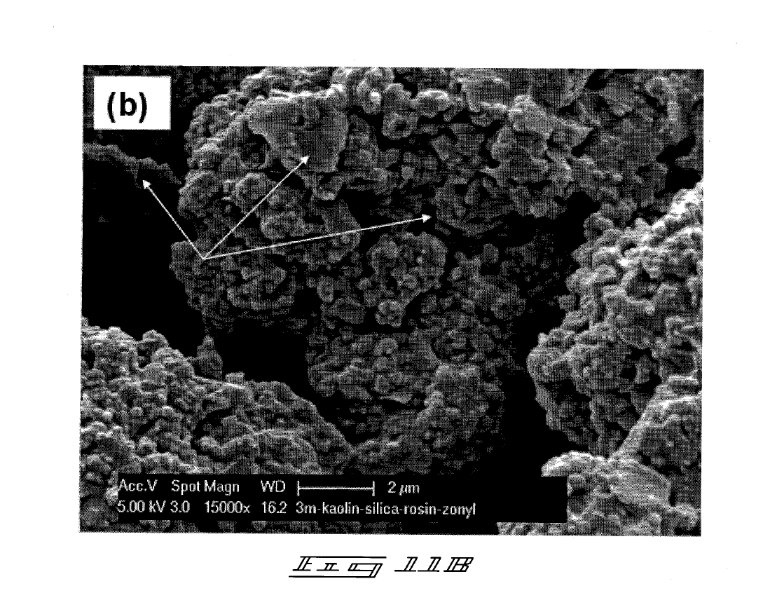

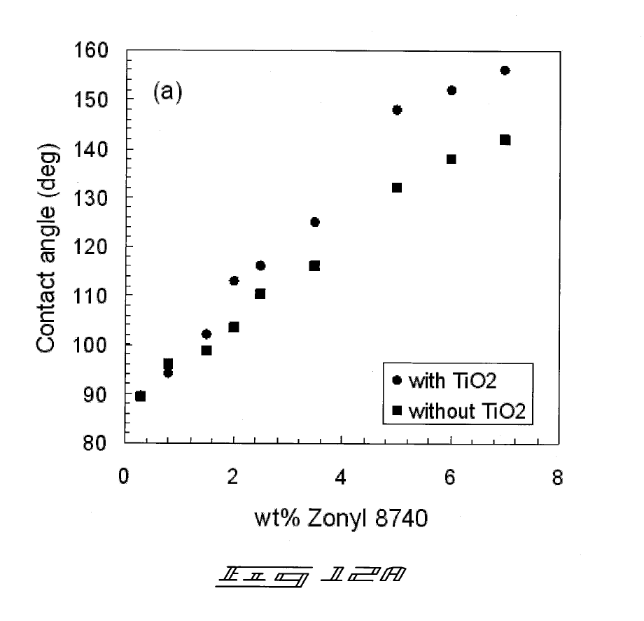

Referring to FIG. 13((A) 50 μm scale bar and (B) 1 μm scale bar) as well as FIG. 14((A) 2 μm scale bar and (B) 100 μm scale bar), an SEM of the composition is provided. The composition can be prepared from a wet chemical solution composed of a nanofiller suspension such as ZnO nanoparticles (Alfa Aesar: Nanoguard), perfluoroalkyl methacrylic copolymer (PMC) (Zonyl 8740, Dupont), and acetone cosolvent (Table 4). To prepare the final hierarchically textured surfaces, the solution can be sprayed onto a substrate such as glass using a Paasche Model VL-SET double action airbrush, for example. The substrate can be coated one time from a distance of approximately 30 cm and then air dried for approximately 12 hours. Both the hydrophobicity and the oleophobicity can be tested using distilled water and hydraulic oil (Mobil DTE 11M), respectively.

TABLE 4
Solution compositions and corresponding
acronyms for textured surfaces

| Name | Surface |
|---|---|
| NC1 | 4% wt. ZnO, 2.4% wt. Perfluoroalkyl |
| | Methacrylic Copolymer, 5.6% wt. Distilled |
| | Water, 88% wt. Acetone Cosolvent |
| | Nanocomposite Coating |
| NC2 | 8% wt. ZnO, 2.4% wt. Perfluoroalkyl |
| | Methacrylic Copolymer, 5.6% wt. Distilled |
| | Water, 84% wt. Acetone Cosolvent |
| | Nanocomposite Coating |

Hydrophobicity and oleophobicity of the nanocomposite surfaces can be quantified by measuring the apparent contact angle (static, θ*ₛₜₐₜ; advancing, θ*_{adv}, and receding, θ*_{rec}) and sliding angle (i.e. roll-off or tilt angle) of 10 μL water and oil droplets on each surface using a KSV Instruments Model CAM 200 goniometer to measure the static contact angle and a Red Lake Motion Pro X high speed digital camera for capturing images of advancing and receding contact angles. By slowly rotating a pivoting platform having the substrate and composite thereon, until droplets began sliding or rolling, the droplet sliding angle can be measured utilizing a Macklanburg-Duncan SmartTool Digital Level/Inclinometer with an accuracy of one tenth of a degree. The surface morphology can be characterized using a Philips XL30 environmental scanning electron microscope (ESEM)

Co-solvents can be selected having a boiling point much lower than water. This may facilitate a substantial portion of the solvent within the spray mist evaporating before impacting the substrate. In some implementations, the solvent can evaporate mainly on the substrate and can lead to non-uniform coverage through mechanisms described as the “coffee stain” effect which can cause the water solvent contact line to pin on the substrate during evaporation, transporting nanocomposite material to the edges and forming multiple rings on the coating surface. The co-solvent acetone may be utilized and can provide a counter to the coffee stain effect and provide for more uniform curing as well as producing nanocomposite slurries that self-assemble to form hierarchical surface morphology upon curing.

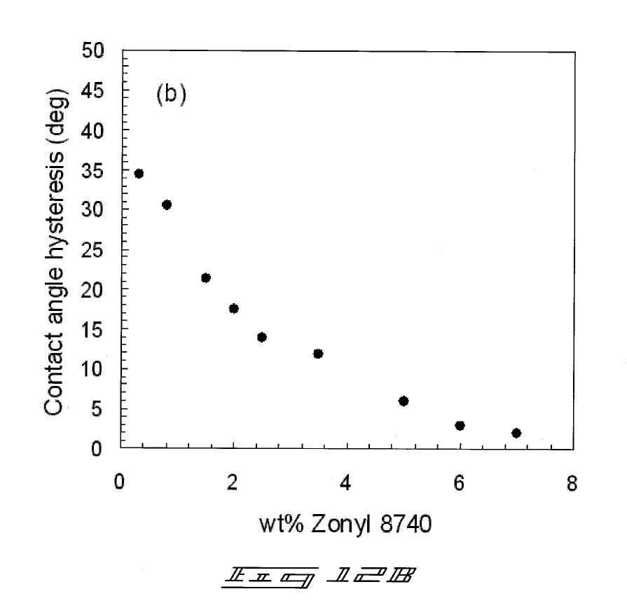

The acetone cosolvent concentration of the solution can be varied, and it can be determined that using acetone instead of water as in previous literature can generate a higher degree of non-wettability (FIG. 15, 10 μL droplets and 3.3:1 nanoparticle:PMC mass fraction). While the hydrophobicity of the nanocomposite increased only slightly, the oil repellency increased from oleophobic to superoleophobic (θ*>150° and low hysteresis). Furthermore, the robustness and homogeneity of the coating can increase dramatically utilizing these methods. Using a water solvent can produce uneven and inhomogeneous superhydrophobicity and oleophobicity throughout the coating surface when applied to most substrates. It can also allow for stationary water and oil droplets to transition from Cassie state to Wenzel state in a matter of minutes (low robustness). As the acetone cosolvent concentration increased (PMC was manufactured in 70% water solution), the non-wettability, robustness, and homogeneity of the coating all transitioned to higher values.

FIG. 14 also shows how the coatings transitioned from a having low degree of micro-morphology to a high degree of 5-10 μm “micro-spheres” of nanocomposite, creating hierarchical surface roughness. Upon achieving this roughness structure, it can be observed that the static contact angle of oil increases significantly from 120° to above 150°. This transition may be explained by the solvent evaporation rate during flight of the atomized slurry towards the substrate. For example, a fast solvent evaporation rate during flight (due to higher acetone concentration) can significantly alter the dispersion concentration of the polymer and nanoparticles within the spray droplet. If most of the solvent evaporates before the droplet reaches the substrate, a droplet with a high concentration of nanoparticles and polymer may impact the surface. This can provide for a “dry” coating as opposed to a “wet” coating.

A slow solvent evaporation rate can produce a thick and wet coating, whereas if most of the solvent evaporates before the spray mist reaches the substrate, it can produce a “dry” coating. In the case of a wet coating, the solvent evaporated mainly on the substrate and led to inhomogeneous wettability through mechanisms described by the coffee stain effect. Therefore, direct spraying of nanoparticle laden, waterborne emulsions can result in undesired inhomogeneous surface morphology due to the solvent contact line pinning on the substrate and transporting nanocomposite material to the edges during solvent evaporation. This effect may cause the formation of multiple rings on the coating surface and inhomogeneous coverage. In the case of a “dry” coating, most of the acetone cosolvent can evaporate in the distance between the spray nozzle and the substrate. This effect can allow the leftover nanocomposite material to form into a spherical shape in the air before contacting and adhering to the substrate.

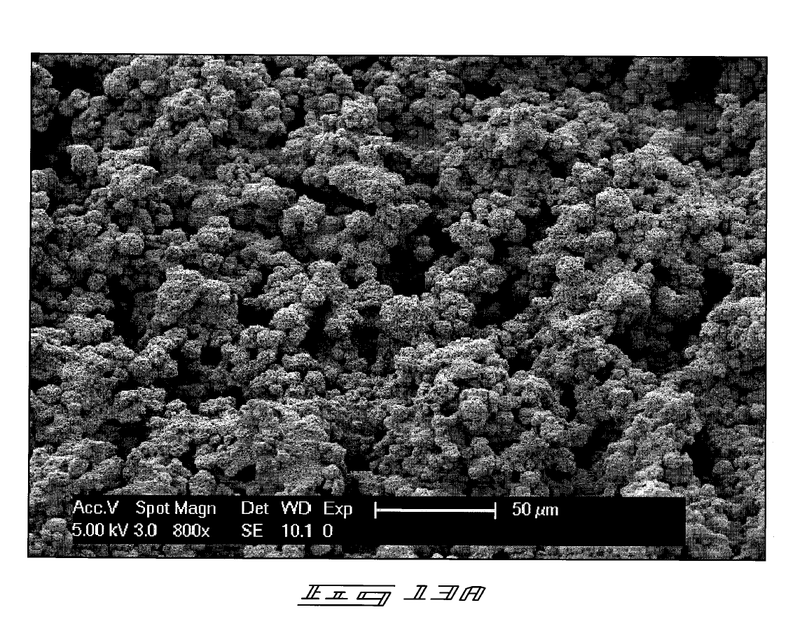

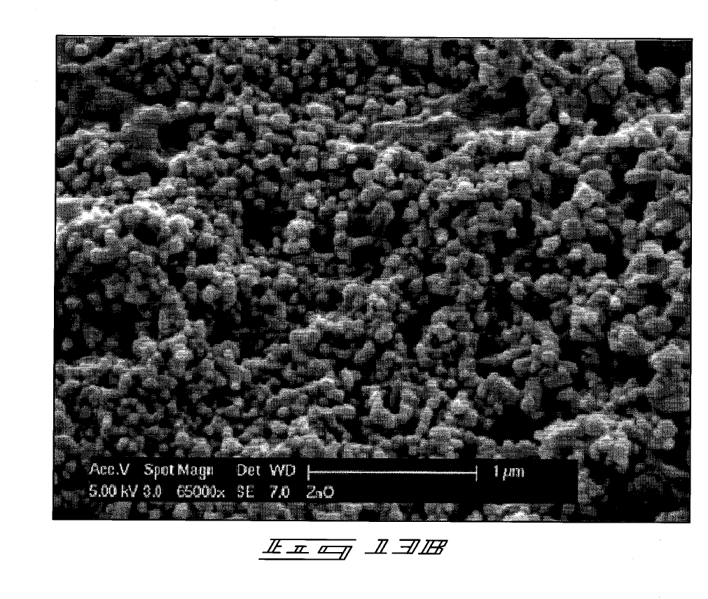

By varying the nanofiller concentration such as the zinc oxide nanoparticle concentration, the amount of PMC exposure on the surface may also be controlled (FIG. 16, 10 μm scale bar showing the composite surface of both zinc oxide nanoparticles and PMC flakes). As shown the composition contains both polymer cells and nanoparticles. This ability may be utilized to create a superoleophobic nanocomposite surface. By allowing the polymer flakes to be exposed, the local surface energy may be reduced considerably as the hydrophobic PMC has a much lower surface energy than the hydrophilic zinc oxide nanoparticles. Compositions of the present disclosure may be characterized by their coat of a layer of polymer as well as a concentration relative to its PMC dispersed in the application solution.

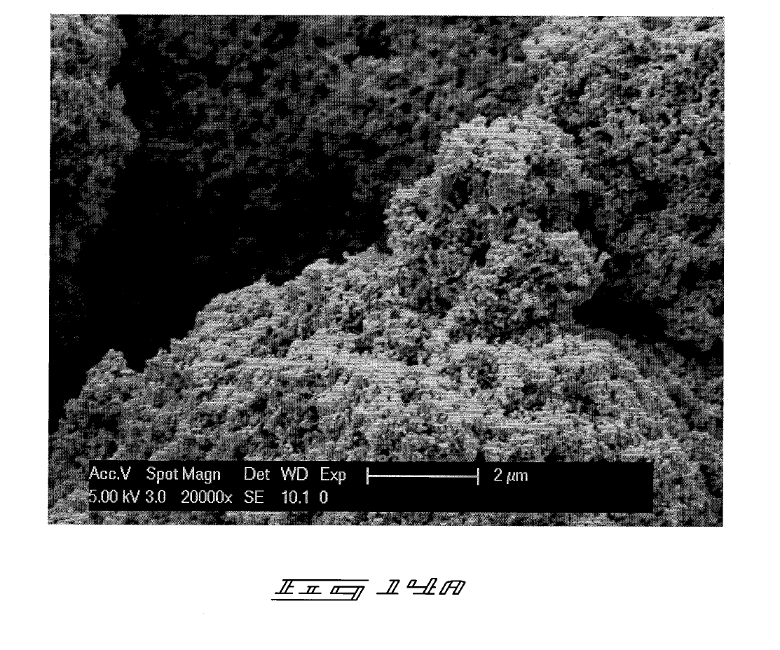

A nanofiller such as a zinc oxide nanoparticle to PMC mass fraction between 0.8 and 3.3 can be optimal for both superhydrophobicity and superoleophobicity (FIG. 17, maximum acetone cosolvent concentration and 10 μL droplets). More specifically, a mass fraction of 1.7 can be used for hydrophobicity and a mass fraction of 3.3 can be used for oleophobicity. The contact angle hysteresis can be a minimum for oil at a zinc oxide to PMC mass fraction of 3.3 (FIG. 17, wettability using 10 μL droplets).

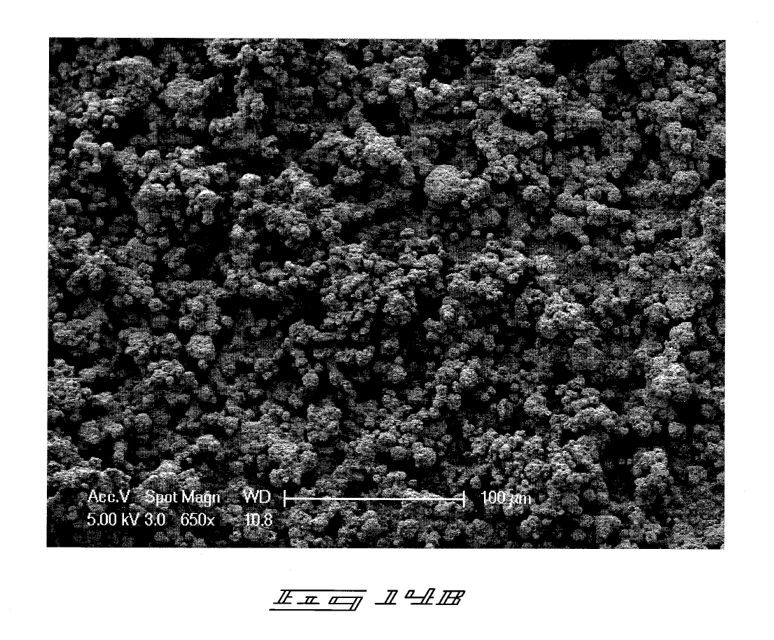

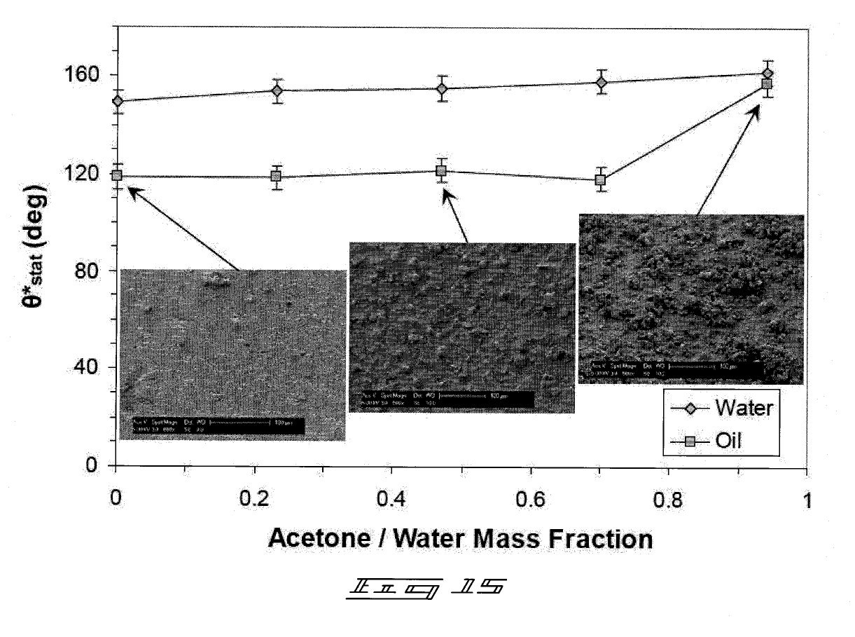

Referring to FIG. 18 A&B, the nanoparticle mass fraction being zero may be related to a loss of appreciable surface roughness from a lack of compatibilizing Zn) nanoparticles. When waterborne PMC solution is exposed to a high concentration of acetone, the polymer dispersion may be disrupted and partial phase separation can occur (see, e.g., FIG. 18B). This separation may result from the block copolymer segment (including primarily quaternary amine functionality) reorienting and causing a partial loss of water solubility. The phase-separated PMC then may agglomerate, becoming much too large and viscous for spray coating and is thereby removed with the main fluoroacrylic backbone remaining as it is soluble in acetone. The resulting composition then cures substantially devoid of surface roughness (FIG. 18A).

This result may reveal the ideal mass fraction for superoleophobicity. This minimum hysteresis value of 4° can indicate the ability of an oil droplet to roll freely on the surface without leaving a trailing stain, which is a rare property due to the extremely low surface tension of oil. Water droplets may show low hysteresis values at all positive zinc oxide nanoparticle mass fractions indicating superhydrophobicity for the entire range.

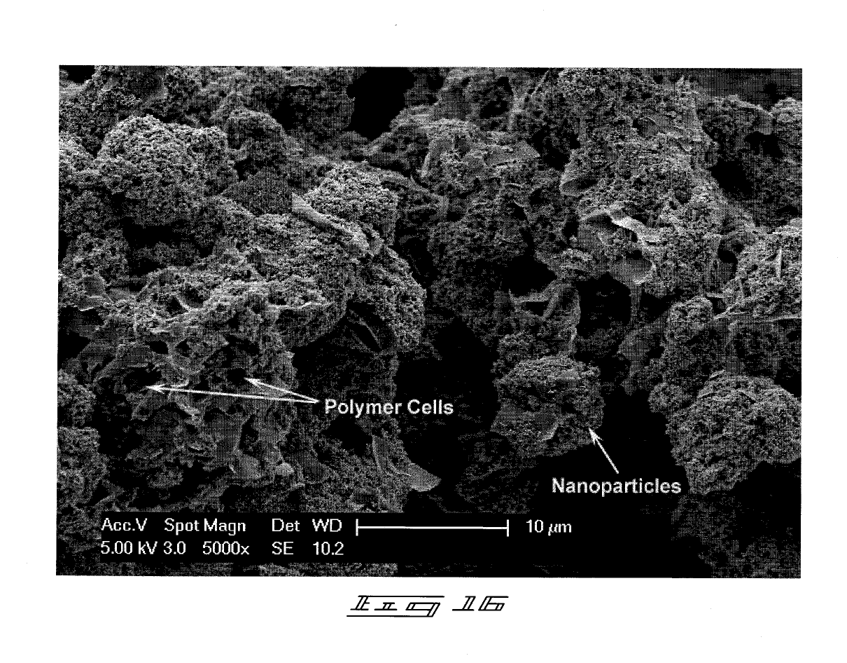

Referring to FIG. 19, contact angle hysteresis of 10 μL droplets for mass fraction performance measurement using select acetone cosolvent is shown. Oil droplet hysteresis can reach a minimum at a ZnO; PMC mass fraction of 3.3. At this level the oil droplet may roll freely from the surface without leaving a trailing stain. Correspondingly, water droplets show low hysteresis values at all positive nanoparticle loadings shown.

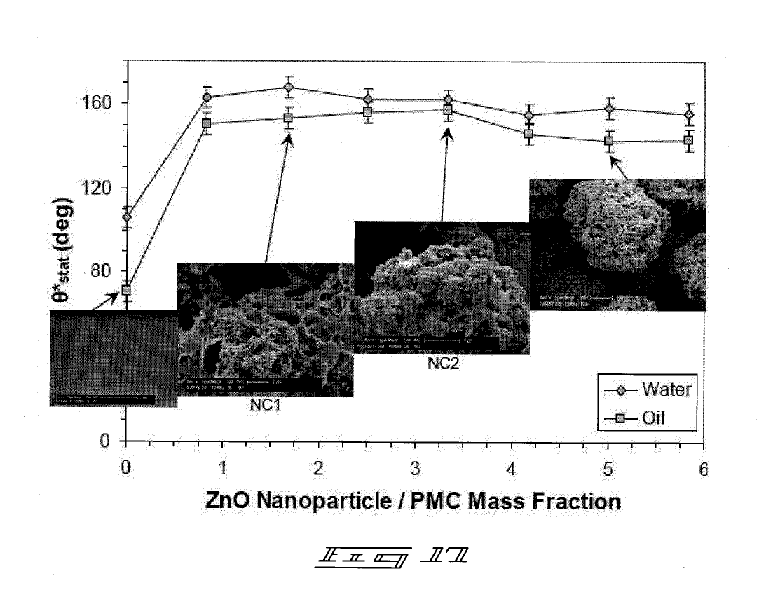

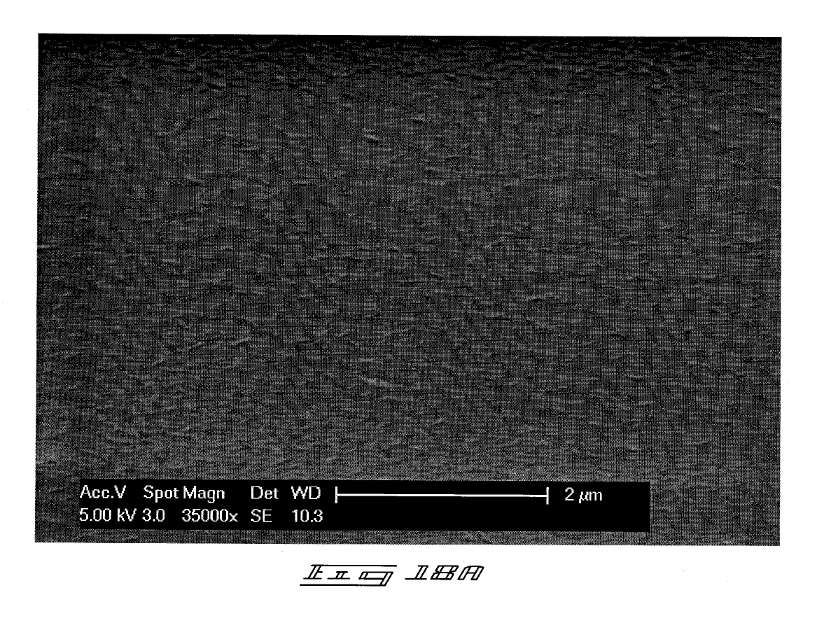

The wettability results can be compared to the Cassie-Baxter model (eq. 3) for a contact area fraction θₛ=0.07 as well as the Wenzel model (eq. 2) for a high and low roughness factor of r=2.96 and r=1.07, respectively (FIG. 20). Both water and oil droplets on NC1 and NC2 appeared to correlate reasonably well to the Cassie-Baxter prediction for a 7% solid-liquid contact area. Additionally, the water data points are located in the first quadrant, indicating that untextured PMC is hydrophobic and is then made more hydrophobic (in this case superhydrophobic) with surface texturing. Conversely, the oil data points are located in the second quadrant, indicating that untextured PMC is oleophilic and is then made oleophobic (in this case superoleophobic) with surface texturing.

The compositions and methods can provide a robust superhydrophobic and superoleophobic nanocomposite coating that can be applied to any substrate by spray and/or brush application in much the same manner as paint is applied. The coating can be applied in large surface area applications with no more equipment than a typical spray applicator. By controlling the solvent evaporation rate in the spray system and the nanocomposite material mass fraction, the nanocomposite coatings can be transitioned from showing inhomogeneous superhydrophobic properties to both robust and homogeneous superhydrophobicity and superoleophobicity.

In accordance with embodiments of the present disclosure, cellulose-based nanocomposite coatings can be fabricated by spray casting (Internal mix atomizer, Paasche, USA) polymer dispersed modified Pickering emulsions on smooth aluminum surfaces. The polymer matrix of the composites can be prepared by compatibilizing cellulose nitrate (as collodion) with a waterborne fluoroacrylic dispersion in solution. The matrix can be a self-cleaning coating with satisfactory durability and low contact angle hysteresis. Sprayed polymer dispersed emulsions cured into porous films can demonstrate measured contact angles as high as 160°. These coatings can be supplemented with fine solid particles such as silica, carbon black and clay, and when adsorbed at liquid-liquid interfaces can act as stabilizers for emulsions, foams, and water droplets replacing surfactants. Emulsions stabilized with such surface active particles can be referred to as “Pickering emulsions” and they have been used in various food and cosmetic products as well as templates for functional composite materials. Particularly, layered silicate stabilized emulsions may be utilized for consumer and pharmaceutical products. Table 5 demonstrates example ingredients and composition of the cyclomethicone-based Pickering emulsion stabilized by layered silicate particles.

TABLE V
Composition details of the layered silicate stabilized
Pickering emulsion with no surfactant or dispersant.

| | Weight | |
|---|---|---|
| Ingredient | percent (%) | Function |
| Water | 60 | Aqueous phase |
| Decamethylcyclopentasiloxane | 16 | Cyclomethicone as oil |
| | | phase |
| Dodecamethylcyclohexasiloxane | 10 | Cyclomethicone as oil |
| | | phase |
| Aluminum silicate clay | 8 | Stabilizer |
| Aminoalkyl-functional | 4 | Emulsifier |
| polydimethylsiloxane | | |
| Aminoalkoxy dimethyl | 2 | Emulsifier |
| polysiloxane | | |

As prepared emulsion viscosity was ~400 cp at 500/s shear rate. Cyclomethicones and layered silicate particles were provided by 3M, USA.

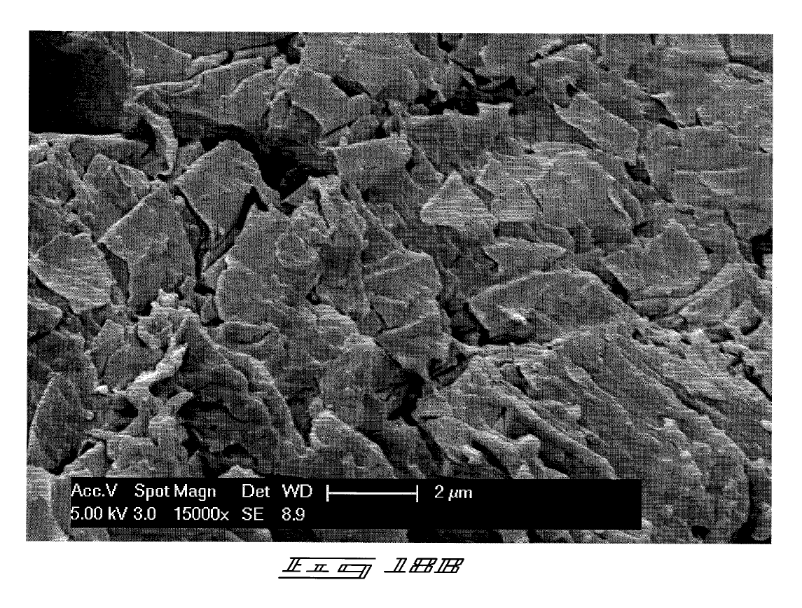

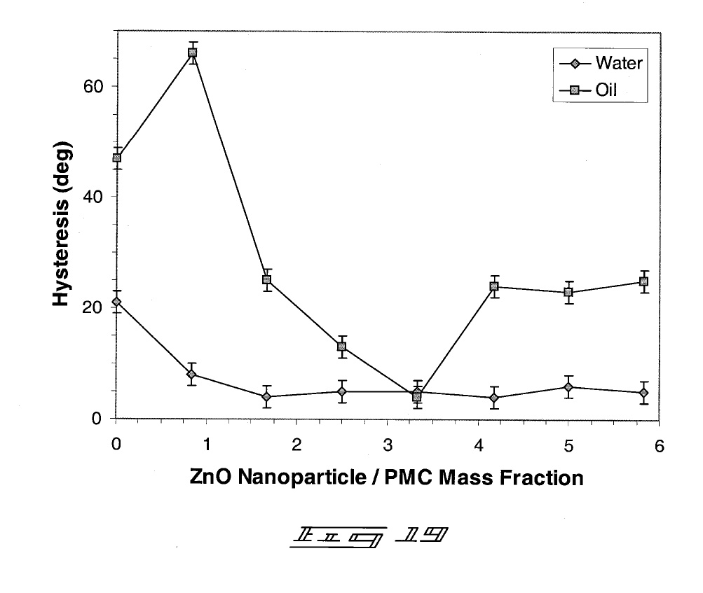

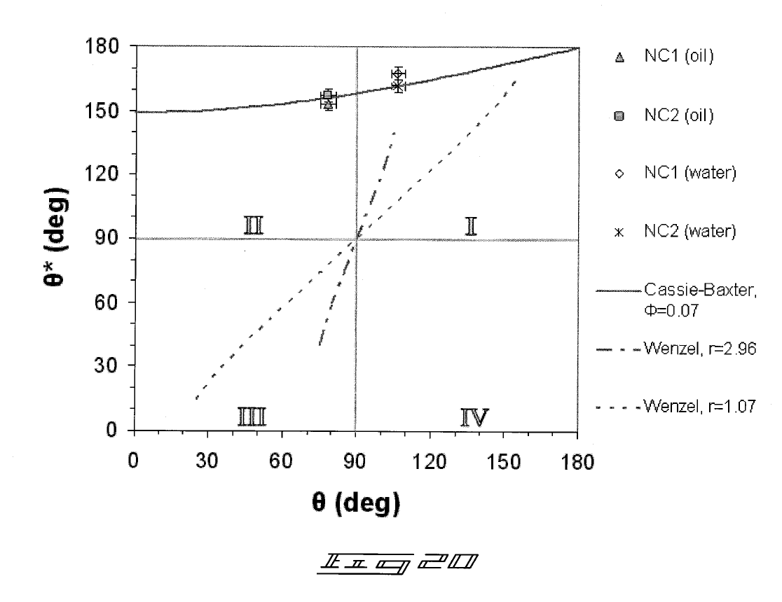

Layered silicate particle concentration of 8% wt. can be sufficient to stabilize the emulsion. The Pickering emulsion can be used to compatibilize otherwise incompatible collodion (8% wt. CN; Sigma-Aldrich, USA) and the waterborne fluoroacrylic polymer (Zonyl 8740, DuPont, USA) solutions. To obtain highly water repellent coatings, the Pickering emulsion can be modified by blending with a zinc oxide (ZnO) nanofluid (50% wt. colloidal dispersion in acetate, Alfa Aesar, USA). Before dispersing the polymers, the nanofluid modified emulsion can be sprayed onto a smooth aluminum foil by reducing its viscosity with ethanol. After annealing at 100° C. for half an hour, a hydrophobic and porous film with hierarchical surface roughness features formed as seen in FIG. 21(a). The film can demonstrate the desired hierarchical surface topology for a self-cleaning surface displaying Wenzel wetting characteristics. Water repellent coatings can be obtained when the collodion solution is blended into the nanofluid modified Pickering emulsion. The spray cast coating surface morphology of this embodiment is shown in FIG. 21(b). Wetting characteristics of such coatings are shown in FIG. 22(a). Note the high degree of contact angle hysteresis (CAH) on these cellulose nitrate-based bionanocomposites (at [ZnO/Emulsion]=0). These compositions can include ZnO nanoparticles prepared within coatings from collodion/waterborne fluoroacrylic blends dispersed in the as-prepared Pickering emulsions. A quaternary silicone compound in alcohol (Silquat J15; Siltech, Canada) can be used as a compatibilizer so that collodion and Zonyl 8740 could be blended in solution. The collodion and Zonyl 8740 solutions can be diluted with n-methyl-2-pyrrolidone (NMP) and Silquat, respectively and subsequently blended. The blend can be immediately dispersed in the Pickering emulsion and subsequently sprayed. The resulting polymer composite surface morphology is shown in FIG. 21(c). Wenzel type wetting characteristics were measured on these coatings with no apparent sub-micron roughness superimposed on the observed surface roughness (5-25 μm) in the absence of nanoparticles. As shown in FIG. 22(a), for cellulose nitrate-based nanocomposites, measured contact angles reached a maximum) (˜150° when the ratio 1<[ZnO/emulsion]<1.5. Within this range, CAH was close to 15°. Note that a steep decline in CAH can be measured when the ratio [ZnO/emulsion]>0.1.

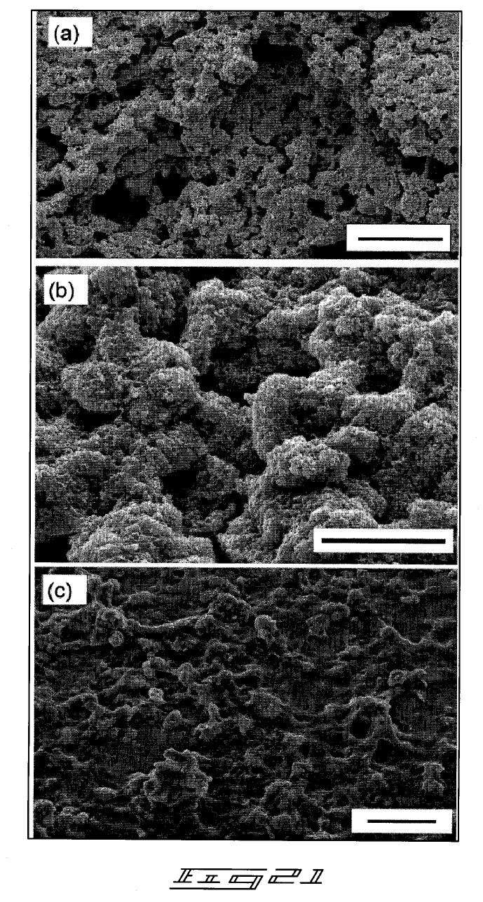

Wetting characteristics of nanocomposites fabricated from Silquat/Zonyl 8740 (Zonyl-based) dispersions in the modified emulsion can be used as a model for comparisons with cellulose nitrate and cellulose nitrate/Zonyl-based bionanocomposites. Measured static contact angles on the Zonly-based coatings were close to 165° with considerably reduced CAH as compared to cellulose nitrate-based coatings at the ideal [ZnO/emulsion] ratio as seen in FIG. 22(a). Wetting characteristics of cellulose nitrate/Zonly based nanocomposites can be similar to that of Zonyl-based coatings when a 1/3 [CN/Zonyl] relative polymer weight concentration is maintained in the atomized mixtures. Moreover, cellulose nitrate/Zonyl based bionanocomposites can display best measured substrate adhesion strength exceeding 300 N/m. To test the durability of the cellulose nitrate, Zonyl and cellulose nitrate/Zonyl-based coatings, thin strips of one side coated aluminum foils can be mechanically triggered to coil and then uncoil repeatedly. Coated foils coiled up readily when the edge of a plastic blade was rubbed against the uncoated surface as shown in the photograph of FIG. 22(b). Change in static water contact angles can be measured for each coating at the end of each coil-uncoil cycle. As seen in FIG. 22(c), cellulose nitrate/Zonyl-based bionanocomposites can withstand more than 30 cycles maintaining high degree of water repellency, whereas, cellulose nitrate and Zonyl-based coatings failed by partially flaking off the substrates after 15 to 22 cycles respectively. Nanocomposites with no polymer matrix appeared brittle. In FIG. 22(d), the SEM image of an intentionally fractured cellulose nitrate/Zonyl based bionanocomposite surface is shown. Interestingly, several polymer fibers ˜200 nm in thickness appear to resist separation of the fractured surface. This could be attributed to the enhanced mechanical properties observed in cellulose reinforced polymers with typical elastic modulus of cellulose fiber inclusions (˜150 nm) reaching 100 GPa. By replacing the collodion solution with collodion-based commercial liquid bandage formulations containing antiseptics (i.e. New-Skin™ solution), and following the identical compatibilization process with Zonyl, equally superhydrophobic bionanocomposites can be fabricated. In general, commercial liquid bandage solutions contain a maximum of 1% antiseptics along with other co-solvents. Although ZnO is a known antimicrobial agent, effect of organic antiseptic additives on the wetting characteristics of the cellulose nitrate/Zonyl based bionanocomposite can be determined. Two common liquid bandage antiseptic crystals, i.e., Dyclonine Hydrochloride and Benzethonium Chloride (MP Biomedicals, USA), which are commonly found in liquid bandages can be dissolved in the cellulose nitrate/Zonyl dispersed modified emulsions in equal parts at different concentrations. Neither antiseptic reacted with any of the polymers used. As FIG. 23 shows, degree of coating superhydrophobicity started declining considerably after overall antiseptic concentrations exceeded 2% wt. Although high antiseptic concentrations seem to be detrimental to superhydrophobicity, quantification of composite wetting performance as a function of antiseptic loading could be beneficial for future applications. Note that from a clinical point of view, antiseptic concentrations close to 1% wt may be sufficient for treatment.

Cyclomethicone-based Pickering emulsion enabled highly water repellent and self-cleaning bionanocomposites were fabricated by spray atomization. This polymer matrix can be a blend of cellulose nitrate and waterborne fluoroacrylic polymer dispersion compatibilized with a silicone quaternary compound. The polymer blend can be dispersible in the ZnO nanofluid modified silicone oil/water Pickering emulsions. Up to 2% organic antiseptic crystals could be embedded into the bionanocomposites without effecting superhydrophobicity. In accordance with another embodiment of the disclosure, rubber reinforced biopolymer nanocomposites can be fabricated that can display sticky and/or self-cleaning superhydrophobicity. A biolubricant can be used as the non-solvent to induce phase inversion of cellulose nitrate from its diluted collodion solution upon spray casting. The biolubricant can be a blend of cosmetics grade cyclomethicone/dimethiconol oils with fruit kernel oils. Table VI shows the constituents of the biolubricant formulation. A secondary function of the biolubricant can be to introduce fatty acids mostly oleic acid) from fruit kernel oils into the nanocomposites. Oleic acid is known to self-polymerize on montmorillonite clay surfaces helping deiaminate layered structures. Three different rubber resins can be blended into the biopolymer nanocomposites i.e., hydrophobic styrene-butadiene-styrene (SBS) rubber, natural rubber (NR) and fluoroacrylic rubber latex (Zonyl 8740, DuPont, USA). Rubber compounding can enhance hydrophobicity and adhesion strength to the substrates.

TABLE VI
Biolubricant composition.

| Ingredient | Weight % | Function | Supplier |
|---|---|---|---|
| Cyclomethicone- | 60 | Oil | Dow-Corning, USA |
| Dimethiconol | | | |
| Avocado Oil | 15 | Oil | K. G. International, |
| | | | USA |
| Apricot Kernel | 15 | Oil | K. G. International, |
| Oil | | | USA |
| Limonene | 3 | Solvent | Sigma-Aldrich, USA |
| Linalool | 4 | Solvent | Sigma-Aldrich, USA |
| Citronellol | 3 | Oil | Sigma-Aldrich, USA |

Both Avocado and apricot kernel oils are a blend of fatty acids mainly composed of oleic acid (~60%), linoleic acid (~15%) and palmitic acid (~20%).

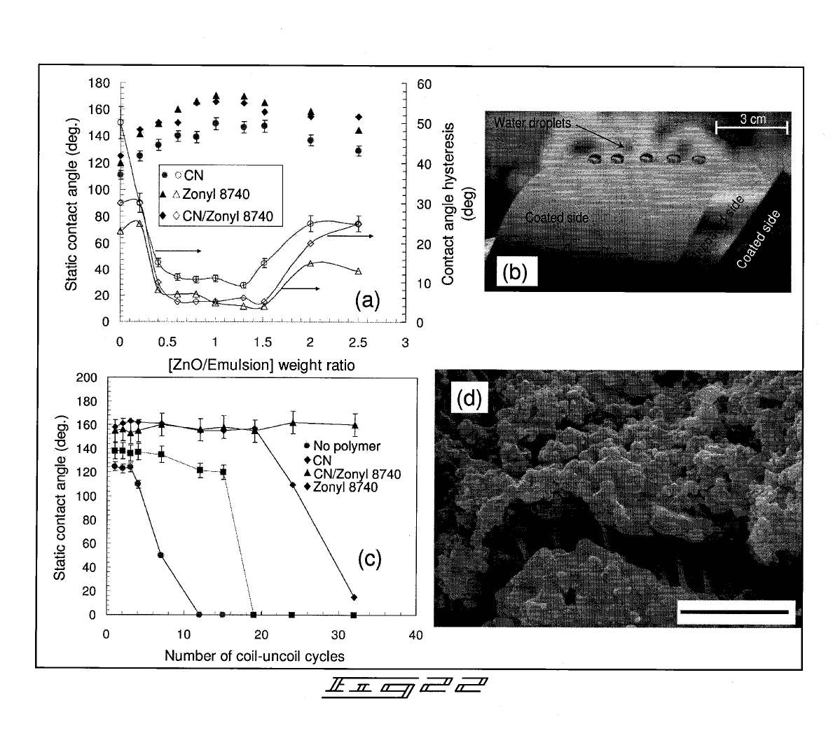

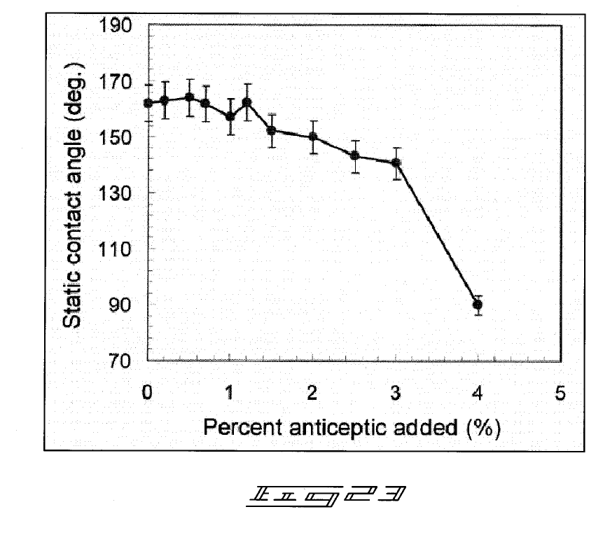

A collodion cellulose nitrate solution (in equal parts) with the biolubricant (non-solvent) can be blended to form a low viscosity gel. The gel can be diluted with ethyl acetate (co-solvent) to enable atomization of the cellulose nitrate/solvent/biolubricant ternary system. Upon spray casting onto aluminum surfaces and thermosetting at 80° C., remarkably different cellulose nitrate polymer film morphology emerged as shown in FIG. 24(a). A network of highly porous cellulose nitrate polymer beads interconnected with sub-micron cellulose nitrate fibers can be observed. The large polymer beads can be made up of a network of sub-micron cellulose nitrate polymer fibers as shown in FIG. 24(b). Such a change in morphology can be also accompanied by the increase in hydrophobicity of the cellulose nitrate film [FIG. 24(c)]. At biolubricant/solvent ratios of about 0.5 static water contact angles reached 110° although CAH remained very high, exceeding 90° as shown in FIG. 24(c).

The ternary system may also be converted into rubber-toughened nanocomposites. For this purpose, surface functionalized (35-45 wt. % dimethyl dialkyl C14-018 amine) montmorillonite clay particles (Nanoclay, Nanocor Inc., USA) can be used. When tethered with fatty amine quaternary salts, montmorillonite platelets can self-aggregate to form hydrophobic surfaces showing Cassie-Baxter type wetting mode.

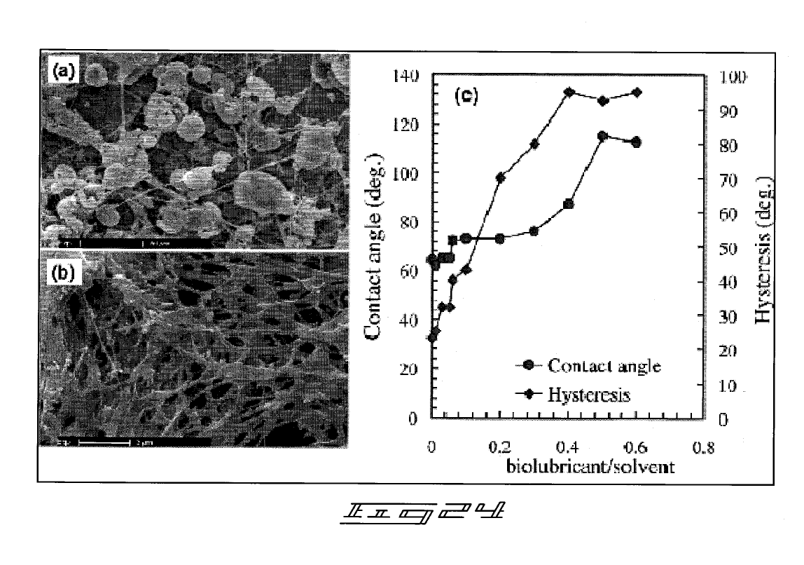

These montmorillonite particles can be dispersed in ethyl acetate at a concentration of 0.1 g; ml forming a stable suspension. SBS rubber cement (20 wt. % in ethyl acetate) can be dispersed in the clay suspension before blending with the ternary cellulose nitrate system. The SBS dispersed clay suspension and the ternary cellulose nitrate system can be miscible and hence, different SBS/cellulose nitrate weight ratios in the blends were prepared to analyze effect of hydrophobic rubber additive on composite superhydrophobicity and adhesion strength. Montmorillonite clay can be dispersible in hydrophobic SBS rubber. In FIG. 25(a) detailed surface morphology of a typical SBS rubber-toughened organoclay/cellulose nitrate nanocomposite is shown. Both micro and nano-scale surface roughness features are present on the surface. Highest static water contact angles can be measured for composites in which SBS/cellulose nitrate weight ratio was 0.4 [FIG. 25(b)]. For this blend, self-cleaning coatings formed when organoclay concentrations exceeded 0.03 g/ml. Contact angle hysteresis was less than 6°. For blends in which SBS/cellulose nitrate<0.4, hydrophobicity can be reduced when organoclay concentrations exceeded 0.05 g/ml. The nanocomposites adhesion strength to aluminum may improve to ˜40 g/cm width for 180° peel.

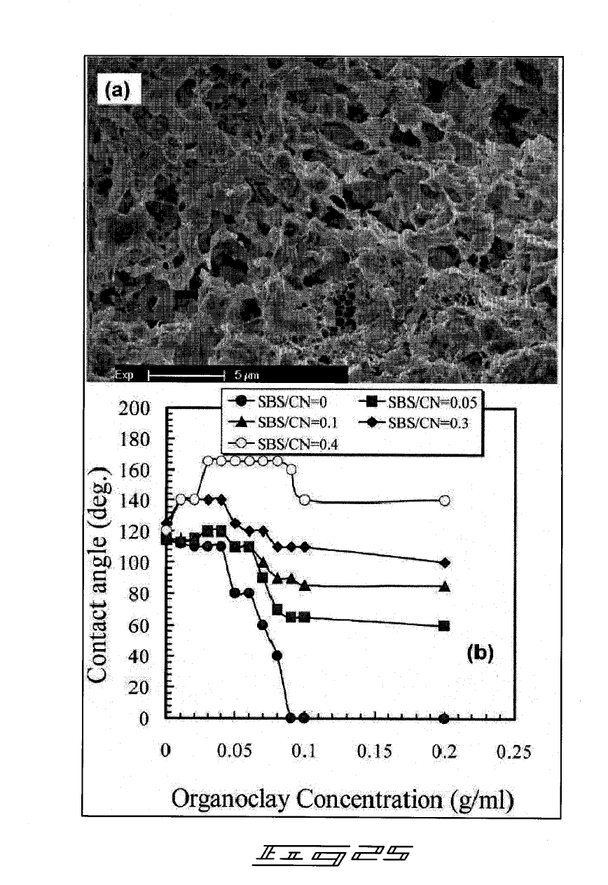

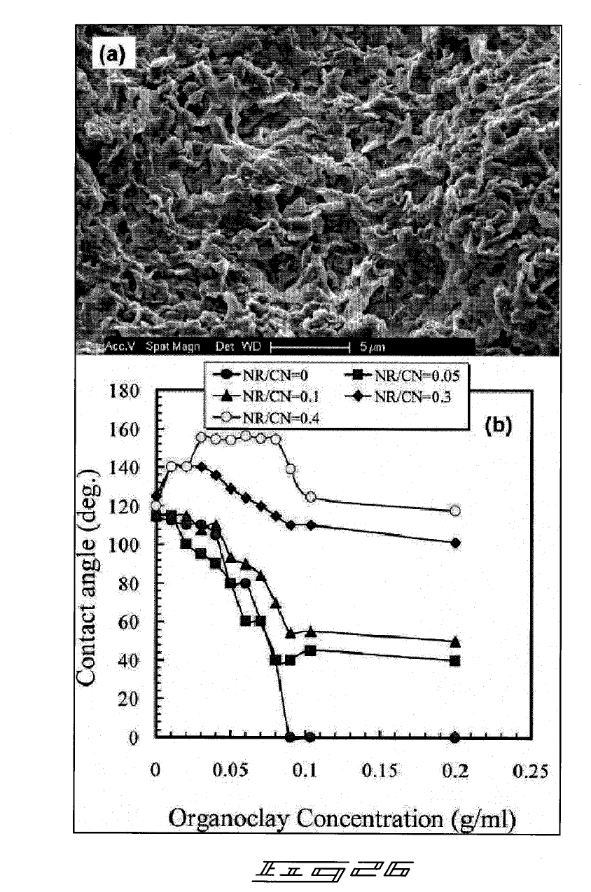

Replacing SBS rubber with natural rubber may also form highly water repellent coatings. Fabrication of the composites can be similar to the previous method. Vulcanites-free NR latex (30 wt. % hexane) can be further diluted with ethyl acetate to 10 wt % and dispersed in the 0.1 g/ml organoclay suspension. NR dispersed suspension was then blended into the ternary cellulose nitrate system. FIG. 26(a) displays a typical surface morphology of the sticky superhydrophobic surfaces obtained (sliding water contact angles>90°). Similar wetting characteristics to SBS composites were observed as a function of biopolymer/rubber ratio and organoclay concentration, however, lower static water contact angles can be measured with contact angle hysteresis>80° [FIG. 26(b)]. Peel strength improved further to ˜60 g/cm width for 180° peel.

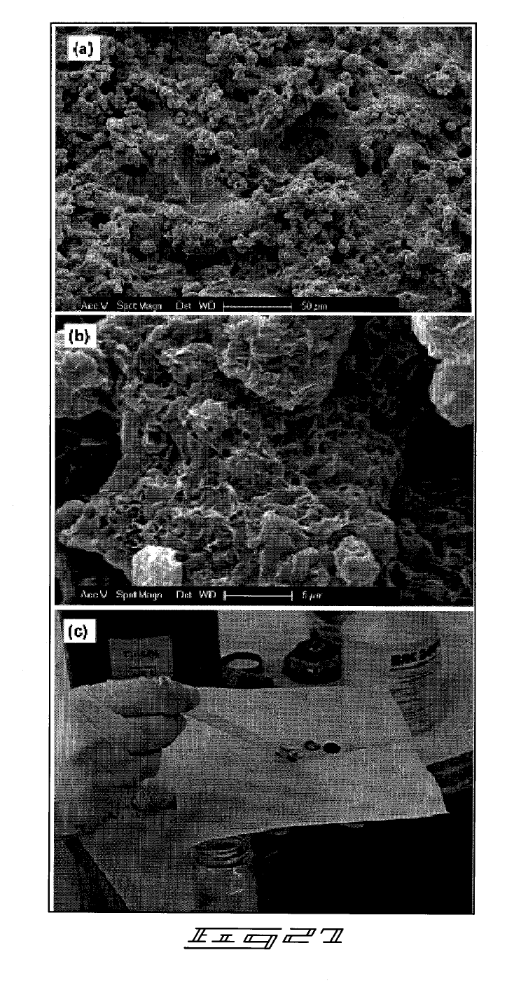

Self-cleaning superhydrophobic biopolymer/rubber/organoclay coatings with strong adhesion to aluminum can be obtained from (Zonyl 8740). Equal volumes of biolubricant and Zonyl 8740 can be emulsified by mixing continuously and diluted with ethyl acetate. Ten ml cellulose nitrate collodion solution can be dispersed in the 0.1 g/ml organoclay nanofluid. Diluted biolubricant/Zonyl and biopolymer/clay dispersions can be mixed in equal volumes for spray coating. Morphology of the coatings is shown in FIGS. 27(a) and 27(b) noting the resemblance to Lotus leaf surface features. Measured peel strength was ˜90 g/cm width for 180° peel. As FIG. 27(b) reveals, the composite surface morphology differs from previous rubber reinforced composites with the formation of micro-scale hydrophobic polymer cells decorated with organoclay particles. Self-cleaning property of the nanocomposites can be tested on coatings contaminated with carbon black powder simulating dirt [FIG. 27(c)].

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. A composition comprising a substrate having a layer thereover, the layer comprising a fluoropolymer and a nanofiller.

2. The composition of claim 1 wherein the nanofiller is a nanoscale particle configured to disperse within the layer.

3. The composition of claim 1 wherein the nanofiller is a metal oxide.

4. The composition of claim 1 wherein the nanofiller comprises a metal from Group VIII of the periodic table of elements.

5. The composition of claim 1 wherein the nanofiller comprises ZnO.

6. The composition of claim 1 wherein the fluoropolymer is a fluoroacrylic polymer.

7. The composition of claim 1 wherein the fluoropolymer comprises a copolymer.

8. The composition of claim 1 wherein the fluoropolymer is water-based.

9. The composition of claim 1 wherein the fluoropolymer is perfluoroalkyl methacrylic copolymer.

10. The composition of claim 1 wherein the substrate comprises one or more of a metal, ceramic, polymer, and/or biomass.

11. The composition of claim 10 wherein the substrate comprises aluminum.

12. The composition of claim 10 wherein the substrate comprises rubber.

13. The composition of claim 10 wherein the substrate comprises textile material.

14. The composition of claim 10 wherein the substrate comprises glass.

15. The composition of claim 10 wherein the substrate comprises concrete.

16. The composition of claim 10 wherein the substrate comprises lexan.

17. The composition of claim 10 wherein the substrate is hydraulic equipment.

18. The composition of claim 17 wherein the substrate is oil transfer tubes.

19. A composition comprising a substrate having a layer thereover, the layer comprising a fluoropolymer and a clay material.

20. The composition of claim 19 wherein the clay material is a clay-in-rosin material.

21. The composition of claim 20 wherein the clay material is one or more of a clay-in-gum rosin, a tall oil fatty acid, and/or thixotropic clay-based metal working fluid.

22. The composition of claim 19 further comprising a nanofiller.

23. The composition of claim 22 wherein the nanofiller is one or both of a metal oxide and/or a nanotube.

24. The composition of claim 23 wherein the metal oxide is TiO₂.

25. The composition of claim 23 wherein the nanotube is a multiwall carbon nanotube.

26. The composition of claim 19 wherein the substrate is one or more of hydraulic equipment, marine vehicle, military vehicle, military arms, and/or construction materials.

27. A method of preparing a composite coating material solution, comprising:
preparing a first solution comprising a fluoropolymer and an acetate;
preparing a second solution comprising a clay material and a nanofiller suspension; and
mixing the first and second solutions to form a composite coating material solution.

28. The method of claim 27 wherein the first solution further comprises a carboxylic acid.

29. The method of claim 28 wherein the first solution comprises:
an acrylic fluoropolymer;
ethyl acetate; and
formic acid.

30. The method of claim 27 wherein the second solution further comprises a carboxylic acid.

31. The method of claim 30 wherein the second solution comprises:
one or more of a clay-in-gum rosin;
a metal oxide suspension; and
trifluoroacetic acid.

32. The method of claim 27 wherein the second solution further comprises a silicone material.

33. The method of claim 32 wherein the second solution comprises:
one or more of a clay-in-gum rosin;
a metal oxide suspension; and
a quaternary silicone.

34. The method of claim 30 wherein the metal oxide suspension further comprises solvent, plasticizer, and surfactant.

35. The method of claim 27 wherein the second solution further comprises an anhydride.

36. The method of claim 35 wherein second solution comprises:
a tall oil fatty acid/montmorillonite;
carbon nanotubes; and
trifluoroacetic anhydride.

37. A method of preparing a composite coating material solution, comprising:
preparing a first solution comprising a fluoropolymer, a silicone material, and a clay-based metalworking fluid;
preparing a second solution comprising a rosin solution and a nanofiller suspension; and
mixing the first and second solutions to form a composite coating material solution.

38. The method of claim 37 wherein the first solution further comprises a carboxylic compound.

39. The method of claim 38 wherein the first solution comprises:
a fluoroacrylic polymer;
a quarternary silicone compound;
formic acid; and
a thixotropic clay-based metal working fluid.

40. The method of claim 37 wherein the second solution further comprises an anhydride and an acetate.

41. The method of claim 37 wherein the second solution comprises:
a rosin gasket sealant;
trifluoroacetic anhydride;
ethyl acetate; and
a metal oxide suspension.

42. A method of applying a composite material layer to a substrate, comprising depositing a solution onto a substrate, wherein the solution comprises a clay material and fluoropolymer.

43. The method of claim 42 wherein the solution further comprises a solvent.

44. The method of claim 43 wherein the solvent comprises one or more of water, alcohol, and an acetate.

45. The method of claim 42 wherein the depositing comprises projecting the solution from a spray applicator.

46. The method of claim 42 wherein the depositing comprises providing the solution to the substrate from brush applicator.

47. The method of claim 42 wherein the depositing comprises dipping the substrate into the solution.

48. A method of applying a composite material layer to a substrate, comprising depositing a solution onto a substrate, wherein the solution comprises a fluoropolymer and a nanofiller.

49. The method of claim 48 wherein the solution further comprises a solvent.

50. The method of claim 49 wherein the solvent is a polar solvent.

51. The method of claim 49 wherein the solvent is one or more of an alcohol, ketone, and water.

52. The method of claim 48 wherein the depositing comprises atomizing the solution.

53. The method of claim 48 further comprising curing the applied composite material after the depositing, the curing comprising providing energy in the form of heat and/or pressure differential.
